(19) United States
(12) Patent Application Publication
(10) Pub. No.: US 2005/0134537 A1
(43) Pub. Date: Jun. 23, 2005

(54) Current amplifying circuit with stabilized output voltage and liquid crystal display including the same

(75) Inventor: Youichi Tobita, Hyogo (JP)

Correspondence Address: MCDERMOTT WILL & EMERY LLP, 600 13TH STREET, N.W., WASHINGTON, DC, 20005-3096, US

(73) Assignee: MITSUBISHI DENKI KABUSHIKI KAISHA

(21) Appl. No.: 10/959,142

(22) Filed: Oct. 7, 2004

(30) Foreign Application Priority Data
Dec. 19, 2003 (JP) 2003-422998(P)

(51) Int. Cl. G09G 3/36

(52) U.S. Cl. 345/87

(57) ABSTRACT

A differential amplification circuit generates a voltage difference corresponding to a voltage difference between an input node and an output node, across first and second nodes. An output circuit generates a voltage and a current corresponding to a voltage at a control node, on the output node. A switch element is provided between the first node and the control node. The differential amplification circuit and the output circuit, when a feedback loop is formed by turning-on of the switch element, operate so as to cause a voltage at the output node to coincide with a voltage at the input node. The switch element is turned off after the voltage at the output node becomes equal to the voltage at the input node by formation of the feedback loop. With such a construction, provided is a current amplifying circuit which is high in stability against oscillating and low in power consumption.

### BACKGROUND OF THE INVENTION

1. Field of the Invention

The present invention relates to a current amplifying circuit using an insulating gate-type field effect transistor. More particularly, the present invention relates to a current amplifying circuit with a stabilized output voltage and to a liquid crystal display using the same in data line driving and generation of a gray-scale voltage.

2. Description of the Background Art

In a liquid crystal display including liquid crystal display elements, each of which is a voltage driven element, a display luminance of each pixel depends on a voltage written into a liquid crystal display element. Especially, in a case where multilevel gray-scale expression is presented by each pixel, a voltage written into a pixel through a data line or the like is necessary to be controlled with high precision so as not to cause a voltage variation accompanying supply of a load current. Moreover, in many cases, a necessity arises for a load current to be supplied while an output voltage is maintained with high precision in electronic equipment other than a liquid crystal display.

Generally, in such cases, a current amplifying circuit is constituted of a combination of a differential amplification circuit using a reference voltage showing a setting value of an output voltage and an actual output voltage as a differential input and an output circuit supplying a current to an output node according to an output of the differential amplification circuit (for example, Kiyoo ITO, Ultra LSI memory, first edition, K. K. BAIFUKAN, Nov. 1994; p 270-271). First of all, description will be given of a configuration and workings of a current amplifying circuit disclosed in the above literature (hereinafter, referred to as a “conventional current amplifying circuit”).

FIG. 26 is a circuit diagram showing a configuration of a current amplifying circuit using a conventional technique.

With reference to FIG. 26, the conventional current amplifying circuit 100# includes a differential amplification circuit 10 and an output circuit 20.

Differential amplification circuit 10 has an operating current source 15 and a current mirror amplifier 30.

Current mirror amplifier 30 includes: p-type field effect transistors (hereinafter, referred to simply as “p-type transistor”) Q1P and Q2P provided as a pair of current mirror loads; and n-type field effect transistors (hereinafter, referred to simply as “n-type transistor”) Q3N and Q4N provided as a pair of input transistors receiving a differential input.

P-type transistor Q1P is connected electrically between a node N5 and a node N6. Node 6 is connected to a voltage source node N1 supplying a high voltage VH1 and a node N6. P-type transistor Q2P is connected electrically between node N5 and a node N7. The gates of p-type transistors Q1P and Q2P are connected in common to node N7.

N-type transistor Q3N is connected electrically between node N6 and a node N8 and n-type transistor Q4N is connected electrically between node N7 and node N8. The gate of n-type transistor Q3N is connected to an input node Ni and the gate of n-type transistor Q4N is connected to an output node No. An input voltage VI is transmitted to input node Ni and an output voltage VO is supplied from output node No.

Operating current source 15 is connected between a voltage source N2 supplying a low voltage VL1 and node N8 and supplies an operating current I1 of a current mirror amplifier 30.

An output circuit 20 includes: a p-type transistor Q5P, which is an “output transistor”; and a constant current source 25, which is a “current limiting circuit”. Output transistor Q5P is connected electrically between a voltage source node N3 supplying a high voltage VH2 and output node No. Constant current source 25 is connected between a voltage source node N4 supplying a low voltage VL2 and output node No. A capacitance element Cc for effecting dominant pole compensation is connected to output node No as an example of phase compensation for prevention of oscillation of the circuit.

Current mirror amplifier 30 operates receiving supply of operating current I1 and while in operation, generates a voltage difference corresponding to a voltage difference between input voltage VI inputted to the gates of input transistors Q3N and Q4N and output voltage VO, across nodes N6 and N7. A voltage difference between nodes N6 and N7 exhibits a value obtained by amplifying a voltage difference (VO−VI) with a differential amplification operation of current mirror amplifier 30.

In output circuit 20, a current corresponding to a voltage at node N6, that is an output voltage of current mirror amplifier 30, is, on the one hand, supplied to output node No with output transistor Q5P, while on the other hand, in constant current source 25, a limited constant current I2 is supplied to voltage source node N4 from output node No.

Gate voltages of input transistors Q3N and Q4N of current mirror amplifier 30 are controlled so as to be equal to each other by the workings of a feedback loop formed in connecting the gate of output transistor Q5P to an output node (node N7) of current mirror amplifier 30, so output voltage VO is controlled so that it gets near input voltage VI and is eventually equal to input voltage VI at all times.

As a result of this, current amplifying circuit 100# controls so as to realize a relation of VO (output voltage)=VI (input voltage) and on top of that, can supplies an output current Io having a value obtained by subtracting a constant current I2 supplied from constant current source 25 from a driving current It of output transistor Q5P to output node No. That is, even in a case where an output current from a circuit generating input voltage VI can not be increased, the circuit shown in FIG. 26 can be operated as a current amplifying circuit capable of supplying a larger current at the same voltage to output No.

In Japanese Patent Laying-Open Nos. 2000-148263 and 2002-297248, there have been disclosed various kinds of configurations of voltage generating circuits each with a negative feedback using a differential amplification circuit as indispensable. In Japanese Patent Laying-Open Nos. 2002-258821, 2002-76799 and 3-139908, there have also been disclosed realization of higher performance of a differential amplification circuit and offset correction. Moreover, in Japanese Patent Laying-Open Nos. 2001-159885 and 6-95623, there have been disclosed even configurations each using such a differential amplification circuit in a liquid crystal display.

The conventional current amplifying circuit shown in FIG. 26 has oscillation internally because of working as a negative feedback amplifying circuit. If differential amplification circuit 10 oscillates under influence of an external noise on output node No, output voltage VO becomes unstable. In order to prevent oscillation in differential amplification circuit 10, desirable is a larger operating current I1 supplied by operating current source 15. Hence, increase occurs in power consumption in order to realize stabilization of the operation.

Especially, since adopted in a liquid crystal display is a construction in which configured are driving circuits for data lines related to a pixel matrix and plural (a level of tens to hundreds of pieces) current amplifying circuits described above as a multilevel voltage (or gray-scale voltage) generation circuit for gray-scale expression, power consumption in each current amplifying circuit exerts a great influence on an overall amount of power consumption in a liquid crystal display.

That is, in a case where many of current amplifying circuits are required in configuration, an increase in operating current for stabilizing oscillating exerts a great influence on consumed current of all of the apparatus. Hence, in current amplifying circuits, a construction has been desired that can realize a stable operation during which a danger of oscillation due to an external noise is suppressed.

### SUMMARY OF THE INVENTION

It is an object of the present invention to provide a current amplifying circuit which is high in stability against oscillation and low in power consumption and a liquid crystal display including the same for data line driving or gray-scale voltage driving.

A current amplifying circuit according to the present invention includes: a differential amplification circuit for generating a voltage difference according to a voltage difference between an input node and an output node, across a first node and a second node; an output circuit for generating a voltage and a current corresponding to a voltage at a control node, on the output node; and a feedback loop switch provided between a predetermined one of the first and second nodes and the control node, wherein the differential amplification circuit and the output circuit operate so that, when a feedback loop is formed by turning-on of the feedback loop switch, a voltage at the output node coincides with a voltage at the input node, and the feedback loop switch is turned off after a voltage at the output node becomes substantially equal to a voltage at the input node by formation of the feedback loop.

Preferably, the differential amplification circuit includes: an operating current switch connected in series with a operating current source of the differential amplification circuit between a high voltage source and a low voltage source and for supplying or cutting-off an operating current of the differential amplification circuit, wherein the operating current switch is turned off to cut off the operating current after a voltage at the input node is close to a voltage at the input node.

A current amplifying circuit according to another configuration of the present invention includes first and second current amplifying units.

Each of the first and second current amplifying units includes: a differential amplification circuit for generating a voltage difference according to a voltage difference between an input node and an output node, across a first node and a second node; an output circuit for generating a voltage and a current corresponding to a voltage at a control node, on the output node; and a feedback loop switch provided between a predetermined one of the first and second nodes and the control node.

The differential amplification circuit and the output circuit operate such that, when a feedback loop is formed by turning-on of the feedback loop switch, a voltage at the output node coincides with a voltage at the input node.

The feedback loop switch is turned off after a voltage at the output node becomes equal to a voltage at the input node by formation of the feedback loop.

The output circuit in the first current amplifying unit causes a current corresponding to a voltage at the related control node to flow into the output node and the output circuit in the second current amplifying unit causes a current corresponding to a voltage at the related control node to flow out to the output node.

The input nodes of the first and second current amplifying units are connected electrically to each other and the output nodes of the first and second current amplifying units are connected electrically to each other.

A liquid crystal display according to the present invention includes: a plurality of pixels arranged in a matrix and emitting luminances corresponding to respective display voltages written thereinto; a plurality of gate lines provided to the respective pixel rows and selected cyclically; a plurality of data lines provided to the respective pixel columns; and a data driving circuit for generating the display voltages sequentially in response to display signals indicating the display luminances of the respective pixels to output the display voltages onto the plural data lines.

The data driving circuit includes: a decode circuit for generating a gray-scale voltage corresponding to a decode result of the display signal as the display voltage; and current amplifying circuits provided to the respective data lines.

Each of the current amplifying circuits includes: a differential amplification circuit for generating a voltage difference according to a voltage difference between an input node and an output node, across a first node and a second node; an output circuit for generating a voltage and a current corresponding to a voltage at a control node, on the output node; and a feedback loop switch provided between a predetermined one of the first and second nodes and the control node.

The differential amplification circuit and the output circuit operate such that, when a feedback loop is formed by turning-on of the feedback loop switch, a voltage at the output node coincides with a voltage at the input node.

The feedback loop switch is turned off after a voltage at the output node becomes substantially equal to a voltage at the input node by formation of the feedback loop.

The input node of each current amplifying circuit receives the display voltage from the decode circuit and the output node of each current amplifying circuit is connected to a related one of the plural data lines.

The pixels are, when a corresponding one of the gate lines is selected, connected electrically to a corresponding one of the data lines and the display voltage is written thereinto.

A liquid crystal display according to another configuration of the present invention includes: a plurality of pixels arranged in a matrix and emitting luminances corresponding to respective display voltages written thereinto; a plurality of gate lines provided to the respective pixel rows and selected cyclically; a plurality of data lines provided to the respective pixel columns; and a data driving circuit for generating the display voltages sequentially in response to display signals indicating the display luminances of the respective pixels to output the display voltages onto the data lines.

The data driving circuit includes: a decode circuit for generating a gray-scale voltage corresponding to a decode result of the display signal as the display voltage; and current amplifying circuits provided to the respective data lines.

Each of the current amplifying circuits includes first and second current amplifying units.

Each of the first and second current amplifying units includes: a differential amplification circuit for generating a voltage difference according to a voltage difference between an input node and an output node, across a first node and a second node; an output circuit for generating a voltage and a current corresponding to a voltage at a control node, on the output node; and a feedback loop switch provided between a predetermined one of the first and second nodes and the control node.

The differential amplification circuit and the output circuit operate such that, when a feedback loop is formed by turning-on of the feedback loop switch, a voltage at the output node coincides with a voltage at the input node.

The feedback loop switch is turned off after a voltage at the output node becomes substantially equal to a voltage at the input node by formation of the feedback loop.

The output circuit in the first current amplifying unit causes a current corresponding to a voltage at the related control node to flow into the output node and the output circuit in the second current amplifying unit causes a current corresponding to a voltage at the related control node to flow out to the output node.

The input nodes of the first and second current amplifying units are connected electrically to each other and receive the display voltage from the decode circuit.

The output nodes of the first and second current amplifying units are connected electrically to each other and further connected to a corresponding one of the data lines.

The pixels are, when a corresponding one of the gate lines is selected, connected electrically to a corresponding one of the data lines and the display voltage is written thereinto.

A liquid crystal display according to still another configuration of the present invention includes: a plurality of pixels arranged in a matrix and emitting luminances corresponding to respective display voltages written thereinto; a plurality of gate lines provided to the respective pixel rows and selected cyclically; a plurality of data lines provided to the respective pixel columns; and a data driving circuit for generating the display voltages sequentially in response to display signals indicating the display luminances of the respective plural pixels to output the display voltages onto the data lines.

The data driving circuit includes: a gray-scale voltage circuit for generating plural gray-scale voltages corresponding to plural display luminances for gray-scale to gray-scale voltage nodes, respectively; a decode circuit for selectively outputting one of the gray-scale voltages generated at the gray-scale voltage nodes according to a decoded result of the display signal as the display voltage; and data line driving circuits provided to the respective data lines to drive a corresponding one of the data lines with the display voltage selected by the decode circuit.

The pixels are, when a corresponding one of the gate lines is selected, connected electrically to a corresponding one of the data lines and the display voltage is written thereinto.

The gray-scale voltage circuit includes: a plurality of voltage dividing resistors according to gray levels in number and connected in series between a high voltage source and a low voltage source; and current amplifying circuits provided corresponding to respective connection nodes between the voltage dividing resistors.

Each of the current amplifying circuits includes: a differential amplification circuit for generating a voltage difference according to a voltage difference between an input node and an output node, across a first node and a second node; an output circuit for generating a voltage and a current corresponding to a voltage at a control node, on the output node; and a feedback loop switch provided between a predetermined one of the first and second nodes and the control node.

The differential amplification circuit and the output circuit operate such that, when a feedback loop is formed by turning-on of the feedback loop switch, a voltage at the output node coincides with a voltage at the input node.

The feedback loop switch is turned off after a voltage at the output node becomes substantially equal to a voltage at the input node by formation of the feedback loop.

The input nodes of the current amplifying circuits are connected to the connection nodes between the voltage dividing resistors and the output nodes of the current amplifying circuits are connected to the respective gray-scale voltage nodes.

A liquid crystal display according to yet another configuration of the present invention includes: a plurality of pixels arranged in a matrix and emitting luminances corresponding to respective display voltages written thereinto; a plurality of gate lines provided to the respective pixel rows and selected cyclically; a plurality of data lines provided to the respective pixel columns; and a data driving circuit for generating the display voltages sequentially in response to display signals indicating the display luminances of the respective pixels to output the display voltages to the data lines.

The data driving circuit includes: a gray-scale voltage circuit for generating gray-scale voltages corresponding to plural display luminances for gray-scale to gray-scale voltage nodes, respectively; a decode circuit for selectively outputting one of the gray-scale voltages generated at the gray-scale voltage nodes according to a decoded result of the display signal as the display voltage; and data line driving circuits provided to the respective data lines to drive a corresponding one of the data lines with the display voltage selected by the decode circuit.

The pixels are, when a corresponding one of the gate lines is selected, connected electrically to a corresponding one of the data lines and the display voltage is written thereinto.

The gray-scale voltage circuit includes: a plurality of voltage dividing resistors according to gray-levels in number and connected in series between a high voltage source and a low voltage source; and current amplifying circuits provided corresponding to respective connection nodes between the plural voltage dividing resistors.

Each of the current amplifying circuits includes a first and second current amplifying units.

Each of the first and second current amplifying circuits includes: a differential amplification circuit for generating a voltage difference according to a voltage difference between an input node and an output node, across a first node and a second node; an output circuit for generating a voltage and a current corresponding to a voltage at a control node, on the output node; and a feedback loop switch provided between a predetermined one of the first and second nodes and the control node.

The differential amplification circuit and the output circuit operate such that, when a feedback loop is formed by turning-on of the feedback loop switch, a voltage at the output node coincides with a voltage at the input node.

The feedback loop switch is turned off after a voltage at the output node becomes substantially equal to a voltage at the input node by formation of the feedback loop.

The output circuit in the first current amplifying unit causes a current corresponding to a voltage at the control node to flow into the output node and the output circuit in the second current amplifying unit causes a current corresponding to a voltage at the control node to flow out to the output node.

The input nodes of the first and second current amplifying units are connected electrically to each other and further connected to the connection nodes between the voltage dividing resistors.

The output nodes of the first and second current amplifying units are connected electrically to each other and further connected electrically to a corresponding one of the gray-scale voltage nodes.

A current amplifying circuit of the present invention can, after a voltage at the output thereof becomes equal to a voltage at the input node by a feedback loop formed with a differential amplification circuit and an output circuit, cut off the feedback loop and thereafter can successively generate a voltage and current corresponding to a voltage at a control node when the feedback loop is cut off, on the output node. Therefore, no oscillation occurs even if a voltage variation occurs at the output node under an influence of an external noise or the like to thereby enable a voltage at and a current in the output node to be stabilized. Note that while a voltage at the output node has a possibility to vary over time due to a leakage current from the control node, the voltage suffers almost no change within a given time interval.

Moreover, since an operating current in a differential amplification circuit can be ceased after cut-off of the feedback loop with a operating current switch, lower power consumption can be realized.

In a liquid crystal display according to the present invention, the current amplifying circuit is applied as a data line driving circuit for each data line. Therefore, each data line can be driven exactly and stably with a display voltage corresponding to a display signal while oscillation is prevented. Since power consumption in the data line driving circuits that are required in the same number as the data lines can be suppressed, power consumption of all the liquid crystal display is suppressed.

In a liquid crystal display of another configuration of the present invention, in a gray-scale voltage circuit, a gray-scale voltage obtained by voltage dividing registers connected in series with each other is used as an input voltage for the current amplifying circuits. Since a gray-scale voltage is generated not directly from the divided voltage but through a current amplifying circuit, resistance values of voltage dividing register are designed to be higher, thereby power consumption in the gray-scale voltage circuit to be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a circuit configuration of a current amplifying circuit according to a first embodiment of the present invention;

FIG. 2 is an operating waveform diagram describing operations in the current amplifying circuit shown in FIG. 1;

FIG. 3 is a circuit diagram showing a circuit configuration of a current amplifying circuit according to a first modification of the first embodiment of the present invention;

FIG. 4 is a circuit diagram showing a circuit configuration of a current amplifying circuit according to a second modification of the first embodiment of the present invention;

FIG. 5 is a circuit diagram showing a circuit configuration of a current amplifying circuit according to a third modification of the first embodiment of the present invention;

FIG. 6 is a circuit diagram showing a circuit configuration of a current amplifying circuit according to a second embodiment of the present invention;

FIG. 7 is a circuit diagram showing a circuit configuration of a current amplifying circuit according to a first modification of the second embodiment of the present invention;

FIG. 8 is a circuit diagram showing a circuit configuration of a current amplifying circuit according to a second modification of the second embodiment of the present invention;

FIG. 9 is a circuit diagram showing a circuit configuration of a current amplifying circuit according to a third modification of the second embodiment of the present invention;

FIG. 10 is a circuit diagram showing a circuit configuration of a current amplifying circuit according to a third embodiment of the present invention;

FIG. 11 is an operating waveform diagram describing operations in a feedthrough compensation circuit shown in FIG. 10;

FIG. 12 is a circuit diagram showing a circuit configuration of a current amplifying circuit according to an modification of the third embodiment of the present invention;

FIG. 13 is a block diagram showing a configuration of a current amplifying circuit according to a fourth embodiment;

FIG. 14 is a block diagram showing a configuration of a current amplifying circuit according to an modification of the fourth embodiment;

FIG. 15 is a diagram showing a first configuration example of a current supply circuit according to a fifth embodiment;

FIG. 16 is a diagram showing a second configuration example of the current supply circuit according to the fifth embodiment;

FIG. 17 is a block diagram showing a configuration of a current amplifying circuit according to a sixth embodiment;

FIG. 18 is a block diagram showing a configuration of a current amplifying circuit according to a first modification of the sixth embodiment;

FIG. 19 is a block diagram showing a configuration of a current amplifying circuit according to a second modification of the sixth embodiment;

FIG. 20 is a block diagram showing an overall configuration of a liquid crystal display according to a seventh embodiment of the present invention;

FIG. 21 is a block diagram showing a configuration of a power supply circuit according to an eighth embodiment of the present invention;

FIG. 22 is an operating waveform diagram describing operations in the power supply circuit according to the eighth embodiment of the present invention;

FIG. 23 is a block diagram describing a gray-scale voltage circuit constructed using the power supply circuit according to the eighth embodiment of the present invention;

FIG. 24 is a block diagram showing a power supply system using a current amplifying circuit according to a ninth embodiment of the invention;

FIG. 25 is a diagram describing operations in the power supply system shown in FIG. 24; and

FIG. 26 is a circuit diagram showing a configuration of a current amplifying circuit using a conventional technique.

### DESCRIPTION OF THE PREFERRED EMBODIMENTS

Detailed description will be given of embodiments of the present invention below with reference to the accompanying drawings. Note that the same symbols in the figures indicate the same or related constituents.

First Embodiment

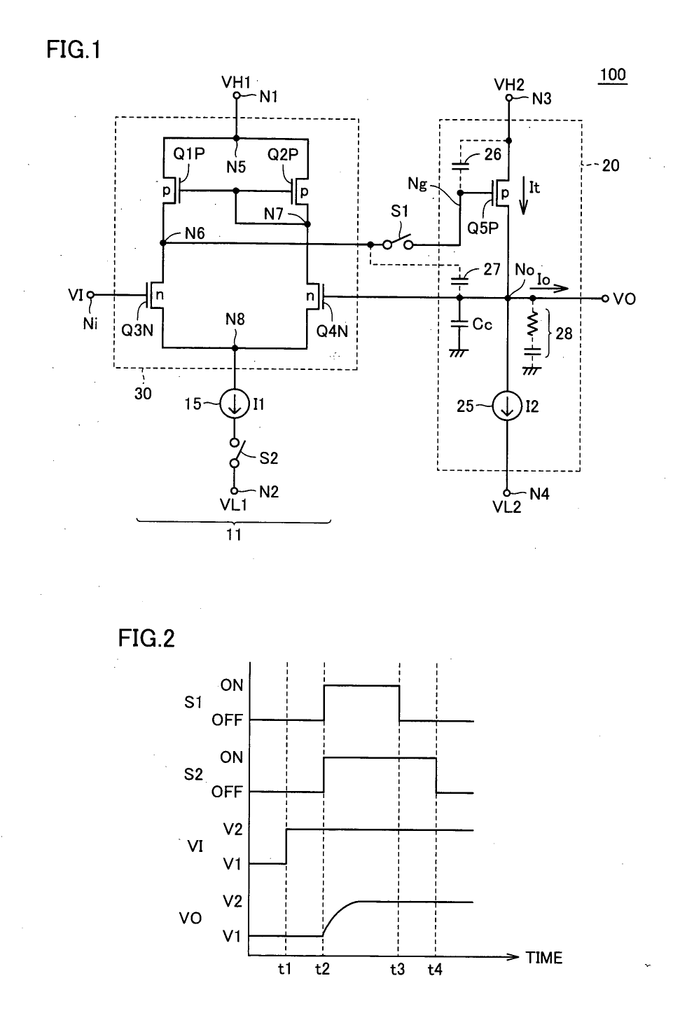

With reference to FIG. 1, a current amplifying circuit 100 according to the first embodiment of the present invention includes a differential amplification circuit 11, output circuit 20 and a switch element S1 provided as a “feedback loop switch”.

Differential amplification circuit 11 is different in comparison with differential amplification circuit 10 shown in FIG. 26 in that differential amplification circuit 11 includes a switch element S2 as an “operating current switch” in addition to operating current source 15 and current mirror amplifier 30. Since operating current source 15 and current mirror amplifier 30 are similar to those shown in FIG. 26 in configuration, detailed descriptions thereof will not be repeated.

Switch element S2 is connected in series with operating current source 15 between a voltage source node N1 (a high voltage source) and a voltage source node N2 (a low voltage source). In the configuration example of FIG. 1, switch element S2 is connected in series with operating current source 15 between a voltage source node N2 and a node N8. Note that since switch element S2 has only to cut off a path of an operating current I1, it may be disposed between voltage source node N1 and a node N5.

Switch elements S1 and S2 can be controlled in whether being turned on or off by a control signal not shown. When switch element S2 is turned on, an operating current is supplied into current mirror amplifier 30 and a voltage difference obtained by amplifying a voltage difference between an input node Ni and an output node No (that is VO−VI) is generated across nodes N6 and N7 equivalent to “first node” and “second node”, respectively, as described in FIG. 26.

A configuration of output circuit 20 is basically similar to that shown in FIG. 26. A node Ng connected to the gate of an output transistor Q5P is equivalent to “control node”, and is connected to an output node N6 of current mirror amplifier 30 through switch element S1. Note that a constant current source 25, which is a “current limiting circuit”, can be replaced with a resistance element. In a case where the resistance element is used, the circuit can be simplified.

In output circuit 20, a miller compensation capacitance 27 for miller compensation can also be used instead of capacitance element Cc for a dominant pole compensation shown in FIG. 26, or a compensation element group 28 for pole zero compensation (a capacitor and a resistor) can also be used instead of capacitance element Cc. Moreover, a holding capacitor 26 for holding a voltage at control node Ng, that is a gate voltage of an output transistor Q5P, is preferably provided between a voltage source node N3 and node Ng.

Note that while, in embodiments described below, holding capacitance 26, mirror compensation capacitance 27 and compensation element group 28 are not shown in the figures, at least one of the element groups can also be disposed similarly to the configuration example of FIG. 1.

Note that high voltages VH1 and VH2 supplied from respective voltage source nodes N1 and N3 on the high voltage side may be the same voltage as each other and low voltages VL1 and VL2 supplied from respective voltage source nodes N2 and N4 on the low voltage side may be the same voltage as each other.

Then, description will be given of operations in the current amplifying circuit shown in FIG. 1 using FIG. 2.

With reference to FIG. 2, after input voltage VI changes to V2 from V1 at a time point t1, switch elements S1 and S2 are turned on at a time point t2.

Thereby, not only does supply of an operating current to current mirror amplifier 30 start, but by formation of a feedback loop, an operation similar to that in current amplifying circuit 100# shown in FIG. 26 is also performed and output voltage VO is gradually close to V2 from V1. Note that switch elements S1 and S2 may not necessarily be turned on simultaneously and may be turned on prior to time point t1.

At a time point t3 after output voltage VO takes the substantially same value as input voltage VI(=V2) by formation of feedback loop, switch element S1 is turned off to cut off the feedback loop. With the cut-off, a voltage at node Ng thereafter does not change from a voltage at time point t3, that is a gate voltage of output transistor Q5P to cause output node No to take V2, independently of an output of current mirror amplifier 30.

A voltage at node Ng is held by the action of a parasitic capacitance mainly including a gate capacitance of output transistor Q5P and holding capacitor 26. That is, with holding capacitance 26 provided, a voltage holding time at node Ng can be longer.

At a time point t4 after time point t3, switch element S2 is turned off to cease supply of an operating current to current mirror amplifier 30. This is because after the cut off of feedback loop due to turning-off of switch element S3, control is effected such that output voltage VO takes the same value as input voltage VI and a current can be supplied to output node No even if a differential amplification operation of current mirror amplifier 30 is ceased.

Therefore, current amplifying circuit 100 according to the first embodiment produces no oscillation even if a variation occurs in voltage at output node No due to an influence of an external noise or the like by cut-off of a feedback loop after stabilization of output voltage VO, can stabilize a voltage at and a current in output node No, and ceases an operating current of current mirror amplifier 30, thereby enabling power consumption to be reduced.

Note that in a case where switch elements S1 and S2 are simultaneously turned off, a normal operation in current mirror amplifier 30 becomes impossible in response to turning-off of switch S2 and a voltage at node Ng when switch element S1 is turned off has a possibility to shift from a desired value of VO(output voltage)=VI (input voltage). Hence, a sequence is adopted in which switch element S2 is turned off at a time point when a predetermined time elapses after switch element S1 is turned off so that an operating current of current mirror amplifier 30 is cut off after a desired gate voltage of output transistor Q5P is, as shown in FIG. 2, secured at node Ng.

Note that an off timing (time point t3) of switch element S1, as described above, is necessary to be later than when output voltage VO takes the same value as input voltage VI(=V2) by formation of feedback loop. For example, a construction can be realized in which a time necessary for controlling output voltage VO is obtained in advance by analyzing a behavior when a feedback loop is formed and a timer (not shown) detecting elapse of the necessary time is provided and thereby specifies an off timing of switch S1. Alternatively, a construction may be adopted in which an off timing of switch S1 is specified in response to a voltage difference between nodes N6 and N7, that is a difference between output voltage VO and input voltage VI.

While a gate voltage of output transistor Q5P reduces with time owing to a leakage current, the gate voltage suffers almost no change in a predetermined time. For example, in a case where current amplifying circuit 100 is applied to a liquid crystal display, it is sufficient if a voltage at output node No has only to be held for a selection interval (generally, tens of μs) of one gate line; therefore, the voltage can be used in a range where reduction in gate voltage of output transistor is practically non-problematical.

First Modification of First Embodiment

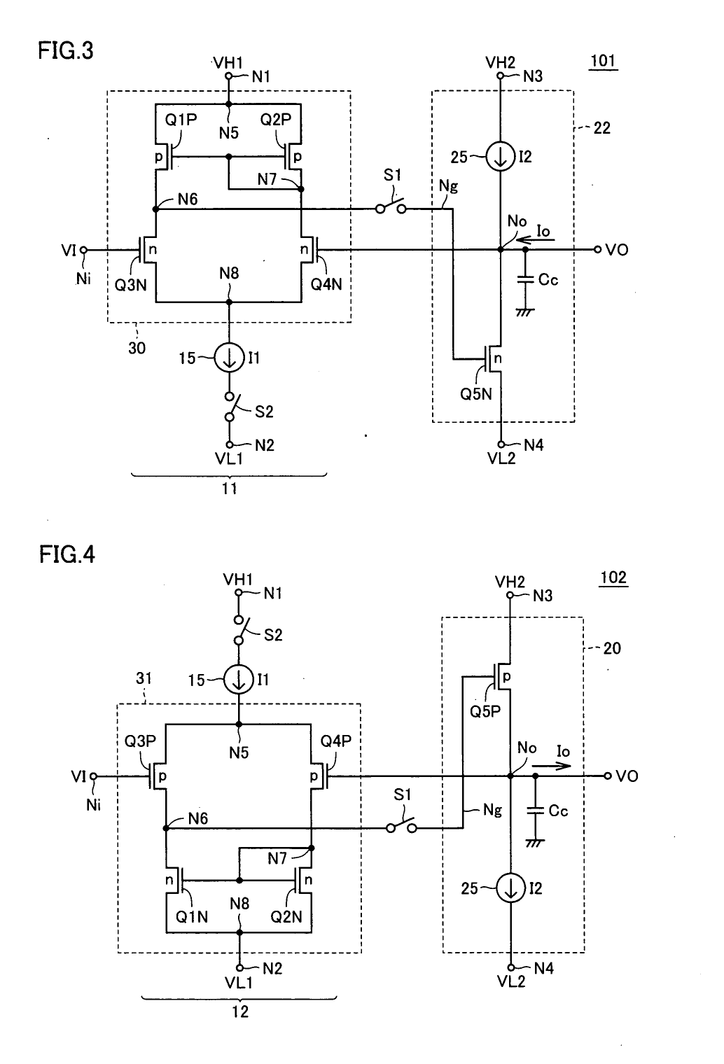

With reference to FIG. 3, a current amplifying circuit 101 according to the first modification of the first embodiment of the present invention includes: a differential amplification circuit 11; a switch element S1; and an output circuit 22. Current amplifying circuit 101 according to the first modification of the first embodiment is different from current amplifying circuit 100 according to the first embodiment in that current amplifying circuit 101 has an output circuit 22 instead of output circuit 20.

Output circuit 22 includes a constant current source 25 and an output transistor Q5N, which is an n-type transistor. Constant current source 25 is connected between a voltage source node N3 (high voltage source) and an output node No and a limited constant current I2 is supplied to output node No from voltage source node N3.

Output transistor Q5N has the gate connected to a node Ng and is connected between output node No and a voltage source node N4 (low voltage source). Node Ng is, similarly to that in current amplifying circuit 100, connected to a node N6 of a current mirror amplifier 30 through a switch element S1, which is a “feedback loop switch”.

Note that switch elements S1 and S2 are controlled according to FIG. 2 in a similar way to that in current amplifying circuit 100.

With such a construction adopted as well, similarly to current amplifying circuit 100, operational stabilization due to prevention of oscillation and lower power consumption are achieved and an a voltage at output node No can be control so as to be equal to a voltage at input node Ni. Note that output circuit 22, which is different from output circuit 20 shown in FIG. 1, causes an output current to flow out from an output node No. That is, current amplifying circuit 101 according to the first modification of the first embodiment is a current amplifying circuit of “pull type”. In contrast thereto, current amplifying circuit 100 in which output circuit 22 causes an output current to flow into output node No is a current amplifying circuit of “push type”.

Second Modification of First Embodiment

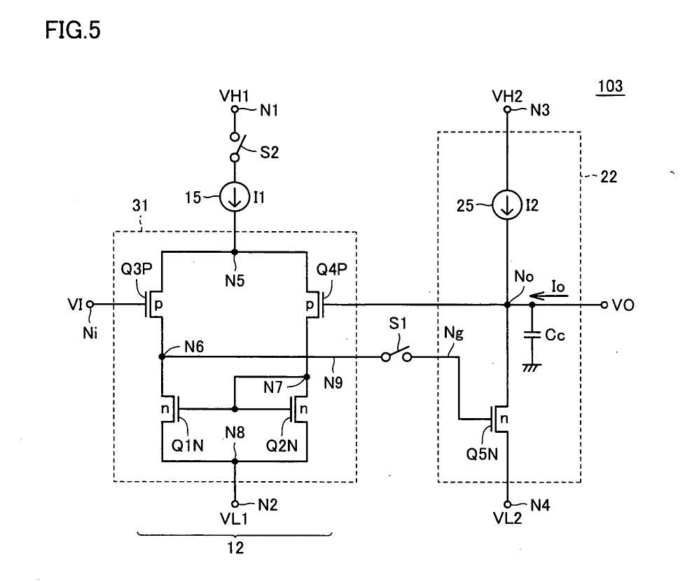

With reference to FIG. 4, a current amplifying circuit 102 according to the second modification of the first embodiment of the present invention includes: a differential amplification circuit 12; an output circuit 20; and a switch element S1. Current amplifying circuit 102 according to the second modification of the first embodiment is different from current amplifying circuit 100 according to the first embodiment in that current amplifying circuit 102 has differential amplification circuit 12 instead of differential amplification circuit 11.

Differential amplification circuit 12 includes: an operating current source 15; a current mirror amplifier 31; and a switch element S2 provided as a “operating current switch”. That is, differential amplification circuit 12 is different in comparison with differential amplification circuit 11 shown in FIG. 1 in that differential amplification circuit 12 has current mirror amplifier 31 instead of current mirror amplifier 30.

Current mirror amplifier 31 is configured so as to have n-type transistors as loads and includes: n-type transistors Q1N and Q2N provided as a pair of current mirror loads; and p-type transistors Q3P and Q4P as a pair of input transistors receiving a differential input.

N-type transistor Q1N is connected electrically between a node N6 and a node N8 and n-type transistor Q2N is connected electrically between a node N7 and a node N8. Node N8 is connected to a voltage source node N2. The gates of n-type transistors Q1N and Q2N are connected to node N7.

P-type transistor Q3P is connected electrically between a node N5 and node N6 and p-type transistor Q4P is connected electrically between node N5 and node N7. The gate of p-type transistor Q3P is connected to an input node Ni and the gate of transistor Q4P is connected to an output node No. In this way, current mirror amplifier 31 is different from current mirror amplifier 30 only in that conductivity types of load transistors are different from those of input transistors, whereas an operation therein, that is voltages generated at nodes N6 and N7 are similar to those of current mirror amplifier 30.

Switch element S1 is connected between output node N6 of current mirror amplifier 31 and node Ng connected to the gate of output transistor Q5P. Switch element S2 is connected in series with an operating current source 15 between voltage source a Node N1 and node N5, and supplies or cuts off a operating current of current mirror amplifier 31.

Therefore, in current amplifying circuit 102 according to the second modification of the first embodiment as well, switch elements S1 and S2 are controlled in a similar way to that shown in FIG. 2, thereby enabling operations similar to those in current amplifying circuit 100 to be realized. That is, a push type current amplifying circuit can be realized in which oscillation is prevented, operational stability is high and power consumption is low.

Third Modification of First Embodiment

FIG. 5 is a circuit diagram showing a configuration of a current amplifying circuit according to the third modification of the first embodiment of the present invention.

With reference to FIG. 5, a current amplifying circuit 103 according to the third modification of the first embodiment includes: a differential amplification circuit 12; an output circuit 22 and a switch element S1.

Differential amplification circuit 12, which is similar to that shown in FIG. 4, includes: a current mirror amplifier 31 using n-type transistors as loads. Output circuit 22 is a pull type output circuit similar to that shown in FIG. 3.

Switch S1 is provided between an output node N6 of current mirror amplifier 31 and a node Ng connected to the gate of an output transistor Q5N. In such a way, with a combination of a differential amplification circuit 12 including a current mirror amplifier using n-type transistors as loads and pull type output circuit 22 as well, switch elements S1 and S2 are controlled in a similar way to that shown in FIG. 2, thereby enabling operations similar to those in current amplifying circuit 100 according to the first embodiment to be realized. That is, a pull type current amplifying circuit can be realized that prevents oscillation, is high in operational stability and low in power consumption.

Second Embodiment

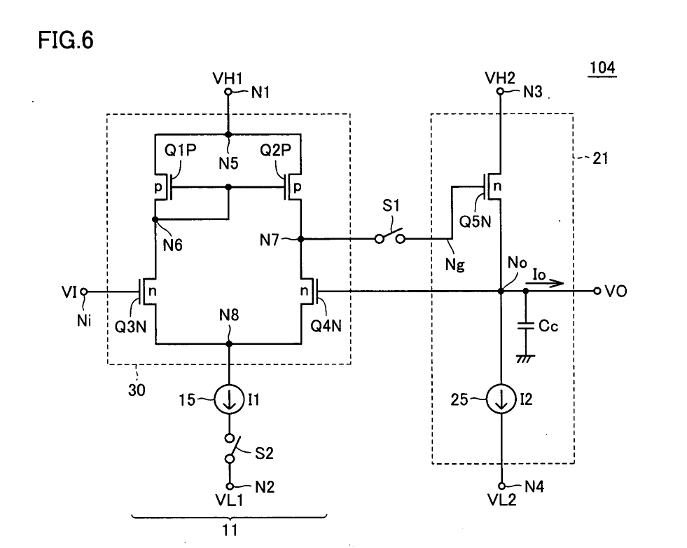

With reference to FIG. 6, a current amplifying circuit 104 according to the second embodiment of the present invention includes a differential amplification circuit 11, a switch element S1 and an output circuit 21. Current amplifying circuit 104 according to the second embodiment is different from current amplifying circuit 100 according to the first embodiment in that current amplifying circuit 104 includes output circuit 21 instead of output circuit 20.

While output circuit 21, which is similar to output circuit 20 shown in FIG. 1, is of a push type causing an output current to flow into an output node No, a polarity of an output transistor is different from that of output circuit 20. In output circuit 21, the drain and source of an output transistor Q5N, which is n-type transistor, are connected to a voltage source node N3 (high voltage source) and output node No, respectively. That is, output transistor Q5N is source-follower connected.

Since in this way, a polarity of an output transistor is in the reverse of that of output circuit 20, the gates of p-type transistors Q1P and Q2P, which are load transistors, in current mirror amplifier 30 are connected to node N6. Switch element S1, which is a “feedback loop switch”, is connected between a node N7 and a node Ng (that is, the gate of an output transistor Q5N). Switch elements S1 and S2 are controlled in a similar way to that in the sequence shown in FIG. 2.

Thereby, in current amplifying circuit 104 according to the second embodiment, a feedback loop is cut off after stabilization of an output voltage VO in a similar way to that in current amplifying circuit 100 according to the first embodiment, thereby enabling a push type current amplifying circuit in which oscillation is prevented to thereby improve operational stability to be realized. Since output circuit 21 is of a source-follower configuration using n-type transistor, current amplifying circuit 104 has an advantage that oscillation is hard to occur during formation of a feedback loop as disclosed in Japanese Patent Laying-Open No. 2000-148263 as well. Hence, operational stability can be further improved.

Note that by adopting an n-type transistor as an output transistor in output circuit 21, a necessity arises for an output voltage from current mirror amplifier 30 to be raised by a voltage drop due to a threshold value in output transistor QN5. Hence, since a high voltage VH1, which is a high voltage source of current mirror amplifier 30, is required to be higher, there arises a worry about increase in consumed current.

In current amplifying circuit 104 according to the second embodiment, however, by turning off of switch element S2 after stabilization of output voltage VO to thereby cut off an operating current of current mirror amplifier 30, an adverse influence can be suppressed that power consumption increases due to a rise in high voltage VH1. Thereby, a push type current amplifying circuit in which oscillation is prevented and an operation is highly stabilized can be realized with a low power consumption by adopting the construction according to the second embodiment.

First Modification of Second Embodiment

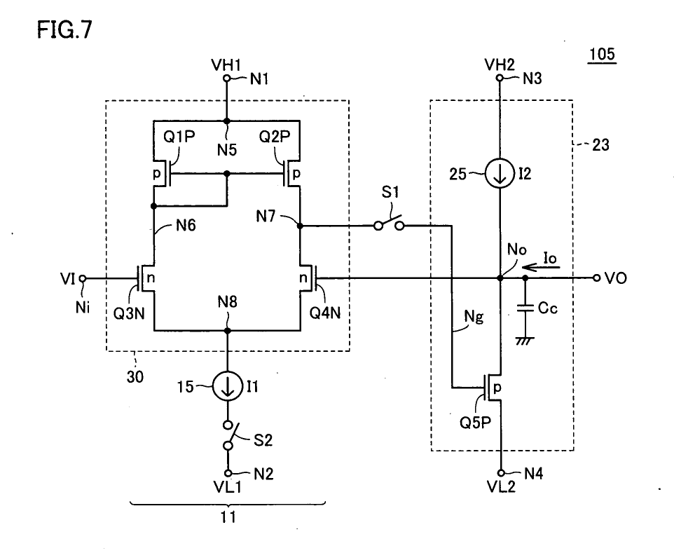

With reference to FIG. 7, a current amplifying circuit 105 according to the first modification of the second embodiment of the present invention includes a differential amplification circuit 11, a switch element S1 and an output circuit 23. Current amplifying circuit 105 according to the first modification of the second embodiment is different from current amplifying circuit 101 according to the first modification of the first embodiment in that current amplifying circuit 105 has output circuit 23 instead of output circuit 22.

While output circuit 23, which is similar to output circuit 22 shown in FIG. 3, is of a pull type causing an output current to flow out from an output node No, a polarity of output transistor is different from that of output circuit 22. In output circuit 23, the drain and source of an output transistor Q5P, which is a p-type transistor, are connected electrically to a voltage source node N4 (low voltage source) and output node No, respectively. That is, output transistor Q5P is source-follower connected.

Since in this way, a polarity of the output transistor is in the reverse of that of output transistor 22, current mirror amplifier 30 is of construction similar to that of FIG. 6. Therefore, switch element S1, which is a “feedback loop switch”, is also connected between a node N7 and a node Ng (that is, the gate of output transistor Q5P). In current amplifying circuit 105 as well, switch elements S1 and S2 are controlled in a similar way. to that in the sequence shown in FIG. 2.

Thereby, in current amplifying circuit 105 according to the first modification of the second embodiment, a feedback loop is cut off after stabilization of output voltage VO in a similar way to that in current amplifying circuit 101 according to the first modification of the first embodiment, thereby enabling a pull type current amplifying circuit in which oscillation is prevented and operation stability oscillation is improved to be realized. Moreover, since output circuit 23 is of a source-follower circuit construction using a p-type transistor, current amplifying circuit 105 has an advantage that oscillation is hard to occur even during formation of a feedback loop. Hence, an operation stability can be further improved.

Note that by adopting a p-type transistor as an output transistor in output circuit 23, a necessity arises for a low voltage VL1, which is a low voltage source of current mirror amplifier 30, to be reduced by a threshold voltage of output transistor Q5P; therefore, there arises a worry about increase in consumed current.

In current amplifying circuit 105 according to the first modification of the second embodiment, however, by turning off switch element S2 after stabilization of output voltage VO to thereby cut off an operating current of current mirror amplifier 30, an adverse influence can be suppressed that power consumption increases due to a fall in low voltage VL1. Thereby, a pull type current amplifying circuit in which oscillation is prevented and an operation is highly stabilized can be realized with a low power consumption by adopting the construction according to the first modification of the second embodiment.

Second Modification of Second Embodiment

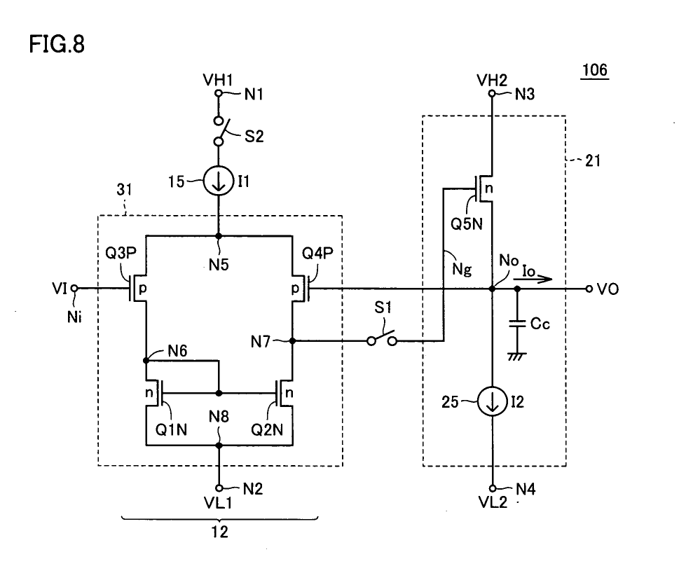

With reference to FIG. 8, current amplifying circuit 106 according to the second modification of the second embodiment includes a differential amplification circuit 12, a switch element S1 and a current amplifying circuit 21. Current amplifying circuit 106 according to the second modification of the second embodiment is different in comparison with current amplifying circuit 104 (FIG. 6) according to the second embodiment in that current amplifying circuit 106 has differential amplification circuit 12 instead of differential amplification circuit 11.

Differential amplification circuit 12, which is similar to that shown in FIG. 4, includes a current mirror amplifier 31 having n-type transistors as loads. Output circuit 21 is, as shown in FIG. 6, a push type output circuit having an n-type output transistor Q5N in source-follower connection.

Switch element S1 is provided between an output node N7 of current mirror amplifier 31 and a node Ng connected to the gate of output transistor Q5N. Even with a combination of differential amplification circuit 12 including a current mirror amplifier having n-type transistors as loads and push type output circuit 21 in this way as well, operations similar to those in current amplifying circuit 104 according to the second embodiment can be realized by controlling switch elements S1 and S2 in a similar way to those shown in FIG. 2. That is, a push type current amplifying circuit can be realized in which oscillation is prevented and operations are highly stabilized with a lower power consumption.

Third Modification of Second Embodiment

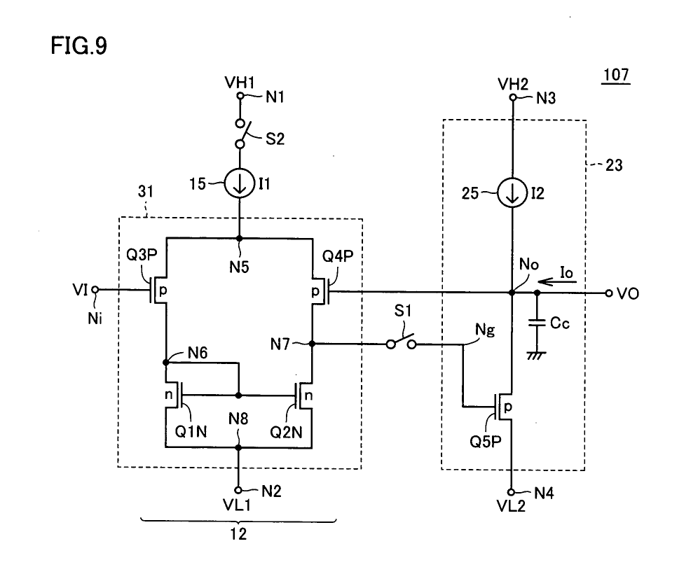

With reference to FIG. 9, current amplifying circuit 107 according to the third modification of the second embodiment includes a differential amplification 12, a switch element S1 and an output circuit 23. Current amplifying circuit 107 according to the third modification of the second embodiment is different in comparison with current amplifying circuit 105 (FIG. 7) according to the first modification of the second embodiment in that current amplifying circuit 106 has differential amplification circuit 12 instead of differential amplification circuit 11.

Differential amplification circuit 12, which is similar to that shown in FIG. 4, includes current mirror amplifier 31 having n-type transistors as loads. Output circuit 23 is, as shown in FIG. 7, a pull type output circuit having a p-type output transistor in source-follower connection.

Switch element S1 is provided between an output node N7 of current mirror amplifier 31 and a node Ng connected to the gate of an output transistor Q5P. Even with a combination of differential amplification circuit 12 including a current mirror amplifier having n-type transistors as loads and pull type output circuit 23 in this way as well, operations similar to those in current amplifying circuit 105 according to the first modification of the second embodiment can be realized by controlling switch elements S1 and S2 in a similar way to those shown in FIG. 2. That is, a pull type current amplifying circuit can be realized in which oscillation is prevented and operations are highly stabilized with a lower power consumption.

Note that while in the first and second embodiments and the modifications thereof, there are exemplified various kinds of variations in regard to transistor polarities (conductivities) of a current mirror amplifier and output transistors, an n-type transistor is larger than a p-type transistor in current driving ability while both being in the same size (gate width/gate length); therefore, it is more advantageous in down sizing of the circuitry to use n-type transistors as load transistors in a current mirror amplifier and an output transistor.

Third Embodiment

In each of current amplifying circuits 100 to 107 according to the first and second embodiments and the modifications thereof, a feedback loop is cut off by turning off of switch element S1 after stabilization of output voltage VO to thereby prevent oscillation and improve operational stability. After cut-off of the feedback loop, the gate voltage of the output transistor is held at a desired level to thereby maintain output voltage VO.

In an actual circuit, switch element S1 is realized with a p-type transistor alone, an n-type transistor alone or both transistors in parallel connection. Therefore, a so-called feedthrough occurs that a voltage at node Ng, that is a gate voltage of the output transistor, shifts from a desired level directly before turning-off of switch element S1 when switch element S1 is turned off by the action of a parasitic capacitance present between the gate electrode and source electrode or drain electrode of a transistor constituting switch element S1.

In order to cope with such a feedthrough, an arrangement of a holding capacitance 26 shown in FIG. 1 has an effect to some extent and in the third embodiment, description will be given of a circuit configuration for compensate a feedthrough.

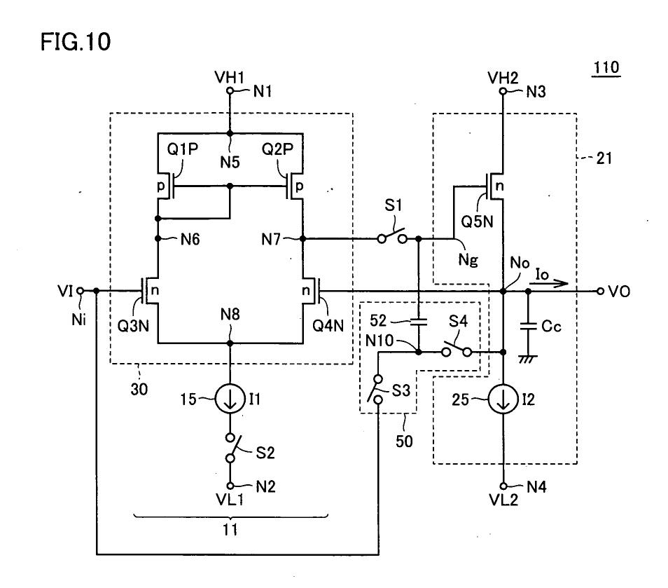

FIG. 10 is a circuit diagram showing a circuit configuration of a current amplifying circuit according to the third embodiment of the present invention.

With the reference to FIG. 10, a current amplifying circuit 110 according to the third embodiment includes a feedthrough compensating circuit 50 in addition to the configuration of current amplifying circuit 104 shown in FIG. 6.

Feedthrough compensating circuit 50 includes a capacitor 52, a switch element S3 equivalent to a “first compensation switch” and a switch element S4 equivalent to a “second compensation switch”.

Switch element S3 is connected between an input node Ni and a node N10 and switch S4 is connected between node N10 and an output node No. Capacitor 52 is connected between node Ng, which is a “control node”, and node N10.

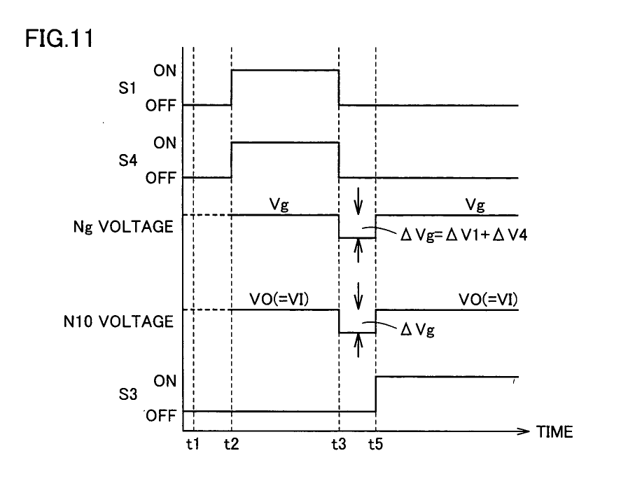

FIG. 11 is an operating waveform diagram describing operations in a feedthrough compensation circuit 50 shown in FIG. 10.

With reference to FIG. 11, switch element S4 is turned on at time point t2 which is a timing similar to that of switch element S1, which is a “feedback loop switch”, and turned off at time point t3. A voltage at node Ng takes a gate voltage Vg of output transistor Q5N, which enables output voltage VO to be equal to input voltage VI, immediately before turning off switch element S1 as shown in FIG. 2.

When switch element S1 is turned off in this state, a feeldthrough voltage variation of −ΔV1 occurs at node Ng. If a capacitance of capacitor 52 in feedthrough compensating circuit 50 is designed so as to be larger than a parasitic capacitance of node N10, the voltage variation of −ΔV1 at node Ng is transmitted almost fully to node N10 by the action capacitor 52.

In a similar way, a voltage variation of −ΔV4 due to a feedthrough is generated at node S10 by turning off of switch element S4 and the voltage variation of −ΔV4 is transmitted almost fully to node Vg. Thereby, each of voltages at node N10 and node Ng are reduced by −ΔVg(ΔVg=ΔV1+ΔV4) after time t3 as a boundary.

Then, when switch element S3 is turned on at a time point t5 later than time point t3, a voltage at node N10 becomes equal to a voltage at input node Ni in a low impedance state, that is an input voltage VI. That is, a voltage at node N10 rises by ΔVg equivalent to a voltage drop at time point t3. Since this voltage variation is transmitted by capacitive coupling through capacitor 52 to node Ng, a voltage at Ng is restored to a gate voltage at a desired level immediately before turning-off of switch element S1 at time point t3. By canceling a feedthrough at node Ng with feedthrough compensating circuit 50 in this way, output voltage VO is stably maintained in current amplifying circuit 110 according to the third embodiment.

Note that capacitor 52 in feedthrough compensating circuit 50 acts as holding capacitance 26 shown in FIG. 1 in an off period of switch elements S1 and S4. Hence, a gate voltage holding time of the output transistor can be increased to improve controllability of output voltage VO when a feedback loop is cut off in addition to the above described feedthrough canceling effect.

Modification of Third Embodiment

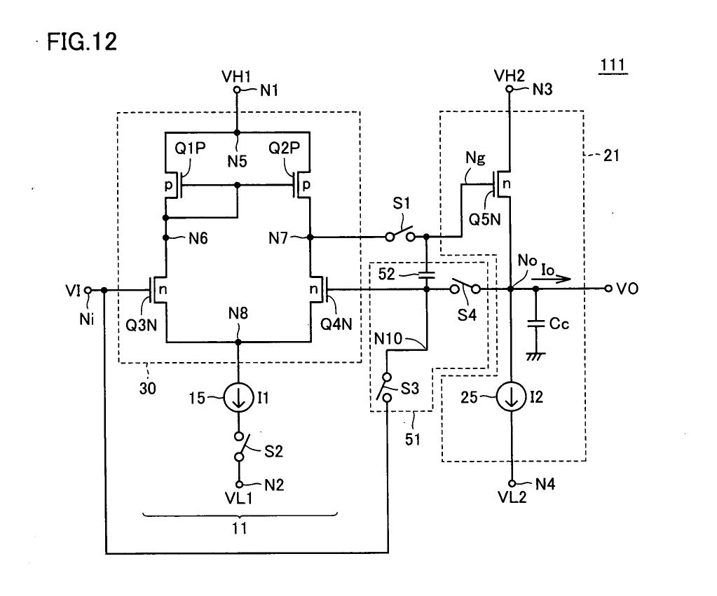

With reference to FIG. 12, a current amplifying circuit 111 according to the modification of the third embodiment is different in comparison with the configuration of current amplifying circuit 110 shown in FIG. 10 in that current amplifying circuit 111 has a feedthrough compensating circuit 51 instead of feedthrough compensating circuit 50.

Feedthrough compensating circuit 51 includes switch elements S3 and S4 and a capacitor 52, and different from feedthrough compensating circuit 50 in that in feedthrough compensating circuit 51, switch element S4 is provided in a feedback path between output node No and the gate of an input transistor Q4N. That is, the gate of input transistor Q4N is connected to node N10 and further connected to output node No through switch element S4. By controlling switch elements S3 and S4 as shown in FIG. 11, current amplifying circuit 111 according to the modification of the third embodiment operates in a similar way to that in current amplifying circuit 110 shown in FIG. 10.

In current amplifying circuit 111 according to the modification of the third example, a wiring portion in which switch element S4 is placed can be shared, an occupancy area of the circuit can be reduced. A demerit that input transistor Q4N acts as a parasitic capacitance of node N10, however, accompanies the reduction in occupancy area.

Note that while in the third embodiment and the modification thereof, a configuration is exemplified in which feedthrough compensating circuit 50 or 51 is added to current amplifying circuit 104 (FIG. 6) according to the second embodiment, any of the other current amplifying circuit 105 to 107 in which the output circuit is of a source-follower configuration can set output voltage VO with a good precision by canceling a feedthrough with addition of feedthrough compensating circuit 50 or 51.

Fourth Embodiment

In the fourth embodiment, a current amplifying circuit is constituted of a combination of a current amplifying circuit of a pull type and a current amplifying circuit of a push type, which are described in the first to third embodiments and the modifications thereof.

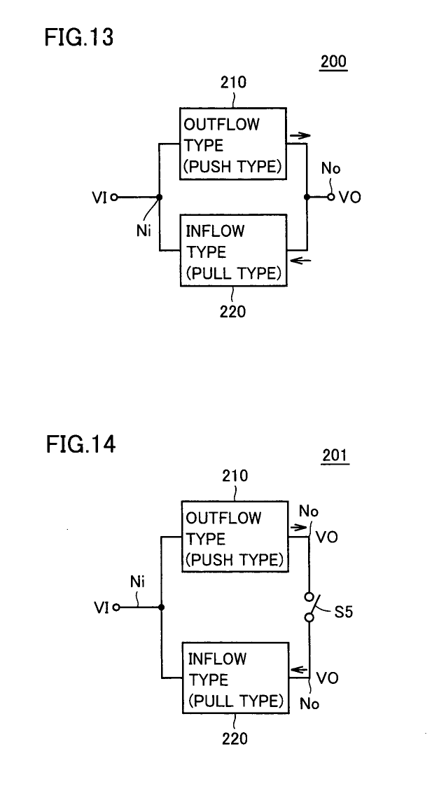

FIG. 13 is a block diagram showing a configuration of a current amplifying circuit 200 according to the fourth embodiment.

With reference to FIG. 13, a current amplifying circuit 200 according to the fourth embodiment includes an outflow type (push type, i.e. source current type) current amplifying circuit 210 and an inflow type (pull type, i.e. sink current type) current amplifying circuit 220. Input nodes Ni of outflow type current amplifying circuit 210 and inflow type current amplifying circuit 220 are connected electrically to each other, and, on the other hand, output nodes No of outflow type current amplifying circuit 210 and inflow type current amplifying circuit 220 are connected electrically to each other. Input voltage VI to current amplifying circuit 200 is inputted to input node Ni connected to each other and output voltage VO of current amplifying circuit 200 is generated at output node No connected to each other.

As outflow type current amplifying circuit (push type) 210, applicable thereto is one of current amplifying circuits 100, 102, 104, 106, 110, and 111, or a current amplifying circuit 106 of a source-follower configuration as an output circuit, added with feedthrough circuit 50 or 51. Similarly, as inflow type current amplifying circuit (pull type) 220, applicable thereto is one of current amplifying circuits 101, 103, 105 and 107, or one of current amplifying circuits 105 and 107 of a source-follower configuration as an output circuit, added with feedthrough circuit 50 or 51.

In outflow type of current amplifying circuit 210, if a predetermined current I2 is reduced by constant current source 25 in output circuit 20 or 21 for lower power consumption, a construction is obtained that is weak against an external noise in a positive direction (in a rise direction of output voltage VO). Similarly, in inflow type of current amplifying circuit 220, if a predetermined current 12 is reduced for lower power consumption, a construction is obtained that is weak against an external noise in a negative direction (in a fall direction of output voltage VO).

In contrast thereto, in current amplifying circuit 200 according to the fourth embodiment, by combining outflow type current amplifying circuit 210 and inflow type current amplifying circuit 220 with each other, a suppressing power against an external noise in the direction, either positive or negative, at output node No can be enhanced while a predetermined current I2 in each current amplifying circuit is reduced for lower power consumption.

Modification of Fourth Embodiment

With reference to FIG. 14, a current amplifying circuit 201 according to the modification of the fourth embodiment is different in comparison with current amplifying circuit 200 (FIG. 13) according to the fourth embodiment in that current amplifying circuit 201 further includes a switch element S5 connected between output nodes No of current amplifying circuits 210 and 220.

Switch S5 is turned on after output voltages of current amplifying circuits 210 and 220 is stabilized in response to setting of input voltage VI, that is at a timing later than time point t3 in FIG. 2. Thereby, output nodes No of current outflow type of current amplifying circuit 210 and current inflow type of current amplifying circuit 220 are disconnected from each other till switch element S5 is turned on.

In contrast thereto, in current amplifying circuit 200 according to the fourth embodiment, since a construction is obtained in which output nodes No of current outflow type of current amplifying circuit 210 and current inflow type of current amplifying circuit 220 are connected to each other at all times, a through current path is easy to be formed between a voltage source node N3 (high voltage source) and voltage source node N4 (low voltage source) through output transistors in output circuits 20 and 21 on the push side and output transistors in output circuits 22 and 23 on the pull side.

Therefore, in current amplifying circuit 201 according to the modification of the fourth embodiment, a through current is prevented from being generated during a period till output voltage VO is stabilized to thereby enable power consumption to be reduced in addition to an effect similar to that of current amplifying circuit 200 according to the fourth embodiment.

Fifth Embodiment

In the fifth embodiment, description will be given of a configuration of a current supply circuit having a function similar to that of switch element S2 operating as an “operating current switch” which is presented in the first to third embodiments and the modifications thereof.

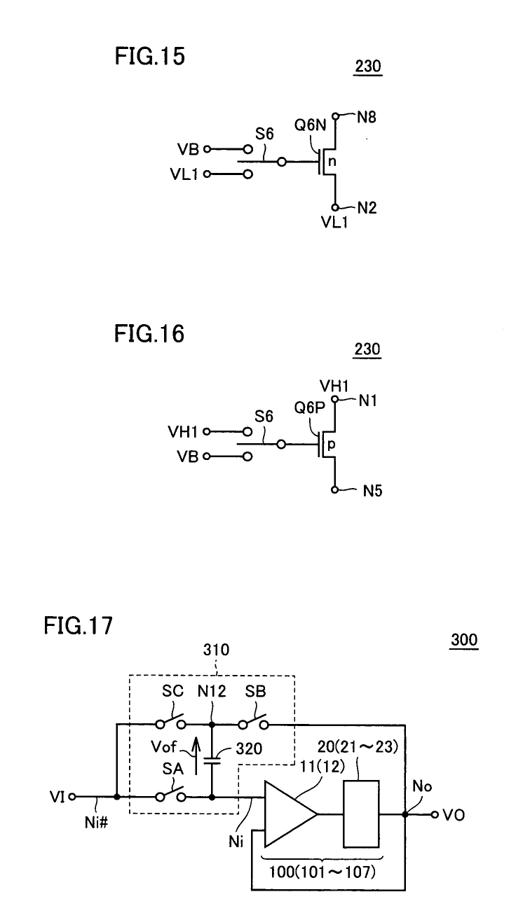

With reference to FIG. 15, a current supply circuit 230 according to the fifth embodiment of the present invention includes an n-type transistor Q6N connected between a voltage source node N2 (low voltage source) and a node N8, and a switch element S6.

Switch element S6 selectively transmits one of a predetermined voltage VB and a low voltage VL1 to the gate of transistor Q6N. When a gate voltage of transistor Q6N is low voltage VL1, transistor Q6N is turned off, therefore, a supply current from voltage source node N2 to node N8 becomes zero to cease supply of an operating current to current mirror amplifiers 30 and 31. That is, produced is a state similar to turning-off of switch element S2 described above.

In contrast to this, when a gate voltage of transistor Q6N is predetermined voltage VB, transistor Q6N causes a current corresponding to predetermined voltage VB to pass through between voltage source N2 and node N8. Hence, by setting predetermined voltage VB properly so as to be adapted for operating currents I1 of current mirror amplifiers 30 and 31, current supply circuit 230 can be used as operating current source 15 described above.

As a result of this, in current amplifying circuits 100 to 107, 110 and 111, a pair of operating current source 15 and switch element S2 can be replaced with current supply circuit 230 shown in FIG. 15, thereby enabling a circuit configuration of each of current amplifying circuits to be simpler.

Alternatively, current supply circuit 230 according to the fifth embodiment, as shown in FIG. 16, can also be constructed with a p-type transistor Q6P and a switch element S6 connected electrically between a voltage source node N1 (high voltage source) and a node N5.

In this case, switch element S6 connects the gate of transistor Q6P to a predetermined voltage VB# in an on period of switch element S2, while connecting the gate of transistor Q6P to a high voltage VH1 in an off period of switch element S2.

As a result of this, in current amplifying circuits 100 to 107, 110 and 111, a pair of operating current source 15 and switch element S2 can be replaced with current supply circuit 230 shown in FIG. 16, thereby enabling a circuit configuration of each of current amplifying circuits to be simpler.

Sixth Embodiment

In a case where a current amplifying circuit described above is applied to a liquid crystal display, the current amplifying circuit has generally been constructed with thin film transistors (TFT) made of polysilicon. Since dispersion in threshold voltage of TFTs in fabrication generally are large, it is expected that an offset voltage is generated in differential amplification circuit 11(or 12) to thereby disable output voltage VO to be set to input voltage VI in a case where a difference in threshold voltage occurs between input transistors Q3N and Q4N (or Q3P and Q4P) in current mirror amplifier 30 (or 31). In the fifth embodiment, description will be given of a circuit configuration capable of compensating such an offset voltage.

FIG. 17 is a block diagram showing a configuration of a current amplifying circuit 300 according to the sixth embodiment.

With reference to FIG. 17, a current amplifying circuit 300 according to the sixth embodiment includes a current amplifying circuit 100 according to the first embodiment, and an offset compensating circuit 310. Offset compensating circuit 310 includes a capacitor 320 for holding an offset voltage, and switch elements SA to SC.

Switch element SA is connected between input node Ni of current amplifying circuit 100 and a node Ni# to which an input voltage VI is inputted. Switch element SB is connected between output node No and a node N12. Switch element SC is connected between node N12 and Ni#. One end of capacitor 320 is connected to input node Ni and the other end thereof is connected to node N12.

Offset compensating circuit 310 compensates an offset voltage in differential amplification circuit 11 applying operations described below to correct a voltage at input node Ni so that current anplifying circuit 300 generates output voltage VO equal to input voltage VI at node No.

At first, not only are switch elements SA and SB turned on, but switch element SC is also turned off and not only is input voltage VI transmitted to input node Ni, but the other end of capacitor 320 is also connected to output node No. In this state, switch elements S1 and S2 in current amplifying circuit 100 (FIGS. 1 and 2) are turned on. Thereby, current amplifying circuit 100 operates so as to cause output voltage VO at output node No to get near input voltage VI having been transmitted to input node Ni.

In a case where there is present none of dispersion in threshold voltage of TFTs included in current amplifying circuit 100, VI=VO; therefore, no voltage difference occurs between node N12 connected to output node 12 and input node Ni, resulting in an offset voltage Vof=0.

In contrast to this, in a case of VI≠ VO because of fluctuation in threshold voltage of TFTs, offset voltage Vof (Vof=VO−VI) is held in capacitor 320.

After output voltage VO reaches a steady state, switch elements SA and SB, on the one hand, are turned off, while switch element SC, on the other hand, is turned on. Thereby, not only is input node Ni disconnected from input voltage VI, but the other end of capacitor 320 is also connected to input voltage VI.

Thereby, a voltage at node N12 takes input voltage VI and a voltage at input node Ni of current amplifying circuit 100 takes a value of (VI−Vof) by the action of capacitive coupling of capacitor 320. Therefore, since in this state, a voltage at input node Ni of current amplifying circuit 100 is shifted (for correction) so as to compensate offset voltage Vof, output voltage VO is correctly set to input voltage VI, which is a rightful target value.

According to current amplifying circuit 300 according to the sixth embodiment, even in a case where, in this way, current amplifying circuit 100 is applied to a liquid crystal display or the like and constituted from TFTs with relatively large dispersion in threshold voltage, output voltage VO can be correctly generated. Note that also applicable instead of current amplifying circuit 100 are current amplifying circuits 101 to 107 according to the modification of the first embodiment, and the second embodiment and the modification thereof, or current amplifying circuits according to the third embodiment and the modification thereof.

First Modification of Sixth Embodiment

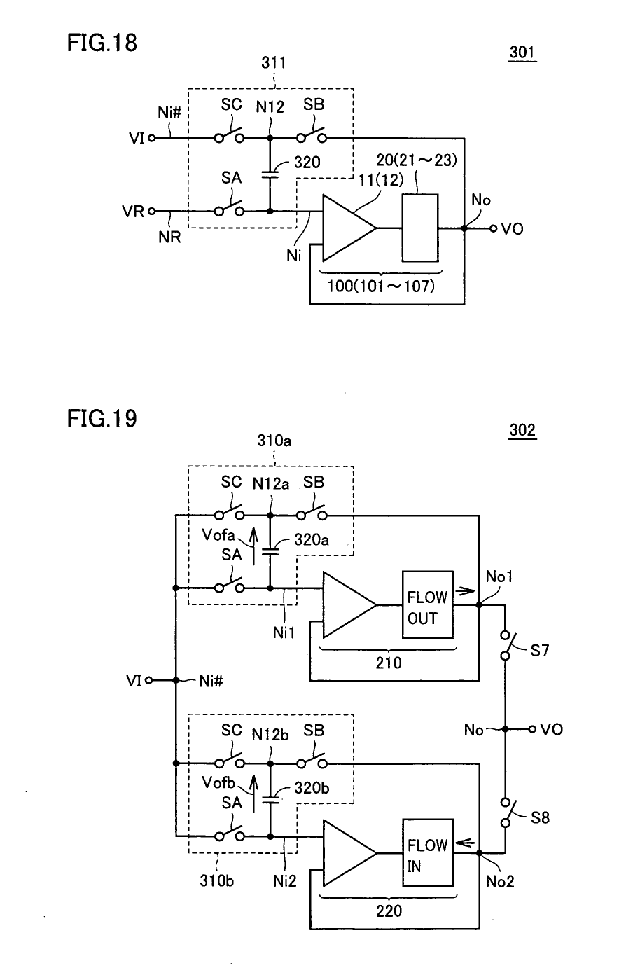

With reference to FIG. 18, a current amplifying circuit 301 according to the first modification of the sixth embodiment is different in comparison with current amplifying circuit 300 according to the sixth embodiment in that current amplifying circuit 301 includes an offset compensating circuit 311 instead of offset compensating circuit 310.

Offset compensating circuit 311,. similarly to offset compensating circuit 310, includes switch elements SA to SC, and a capacitor 320 for holding an offset voltage. In offset compensating circuit 311, however, switch element SA is provided between a node NR and input node Ni of current amplifying circuit 100. A reference voltage VR is inputted to node NR. A switch element S2 is provided between a node Ni# to which an input voltage VI is inputted and a node N12. Switch element SC, similarly to offset compensating circuit 310, is provided between node N12 and an output node No.

In offset compensating circuit 311 as well, similarly to offset compensating circuit 310, at first, not only are switch elements SA and SB turned on, but switch element SC is also turned off and not only is a reference voltage VR transmitted to input node Ni, but the other end of capacitor 320 is also connected to output node No. In this state, switch elements S1 and S2 are turned on in current amplifying circuit 100 and thereby, a voltage difference between input node Ni and output node No, that is an offset voltage Vof=(VO−VR) is held in capacitor 320.

After output voltage VO reaches a steady state, switch elements SA and SB are turned off, while switch element SC is turned on and thereby not only is input node Ni disconnected from reference voltage VR, but the other end of capacitor 320 is also connected to input voltage VI.

Thereby, a voltage at N12 takes input voltage VI and a voltage at input node Ni of current amplifying circuit 100 takes a value of (VI−Vof) by the action of capacitive coupling with capacitor 320. Since in this way, a voltage at input node Ni of current amplifying circuit 100 is shifted (for correction) so as to compensate an offset voltage Vof, output voltage VO is correctly set to input voltage VI, which is a rightful target value.

Especially, in the construction according to the first modification of the sixth embodiment, a load on a signal source generating input voltage VI is greatly reduced. Therefore, in a case where input voltage VI is not a constant voltage, but a signal changing at high speed over time, use of such a current amplifying circuit enables output voltage VO to be correctly followed and set in response to a variation in input voltage VI.

Second Modification of Sixth Embodiment

With reference to FIG. 19, a current amplifying circuit 302 according to the second modification of the sixth embodiment includes a outflow type (push type) current amplifying circuit 210, an inflow type (pull type) current amplifying circuit 220, offset compensating circuits 310a and 310b, and switch elements S7 and S8.

Offset compensating circuit 310a is provided relatedly to outflow type current amplifying circuit 210 and a configuration thereof is similar to that of offset compensating circuit 310 shown in FIG. 17. Similarly, offset compensating circuit 310b is provided relatedly to inflow type current amplifying circuit 220 and a configuration thereof is similar to that of offset compensating circuit 310 shown in FIG. 17.

Switch element S7 is provided between an output node No of current amplifying circuit 302 and output node No1 of outflow type current amplifying circuit 210. Switch element S8 is provided between output node No and an output node No1 of inflow type current amplifying circuit 220.

Then, description will be given of operations in current amplifying circuits 302.

In each of offset compensating circuits 310a and 310b, at first, in a state where switch elements SA and SB are turned on, while a switch element SC is turned off, current amplifying circuits 210 and 220 operate in response to turning-on of switch elements S1 and S2, and offset voltages Vofa and Vofb in outflow type current amplifying circuit 210 and inflow type current amplifying circuit 220 are held in respective capacitors 320a and 320b.

At this stage, switch elements S7 and S8 have been turned off.

After output voltages at output nodes No1 and No2 reach a steady state, in each of offset compensating circuits 310a and 310b, switch element SC, on the one hand, is turned on, while switch elements SA and SB are turned off. Then, switch elements S7 and S8 are turned on and output nodes No1 and No2 of outflow type current amplifying circuit 210 and inflow type current amplifying circuit 220, respectively, are connected to output node No of current amplifying circuit 302.

Thereby, in a state where offset voltages Vofa and Vofb of outflow type current amplifying circuit 210 and inflow type current amplifying circuit 220, respectively, are compensated, output voltage VO can be generated at output node No in a similar way to that in current amplifying circuit 201 shown in FIG. 14. Therefore, operations similar to those in current amplifying circuit 201 according to the modification of the fourth embodiment can be realized by compensating dispersion in threshold voltage of TFTs included in a current amplifying circuit. Note that offset compensating circuit 311 shown in FIG. 18 can also be applied to each of offset compensating circuits 310a and 31b.

Seventh Embodiment

In the seventh embodiment, description will be given of an configuration example in which a current amplifying circuit according to the present invention is applied to a liquid crystal display.

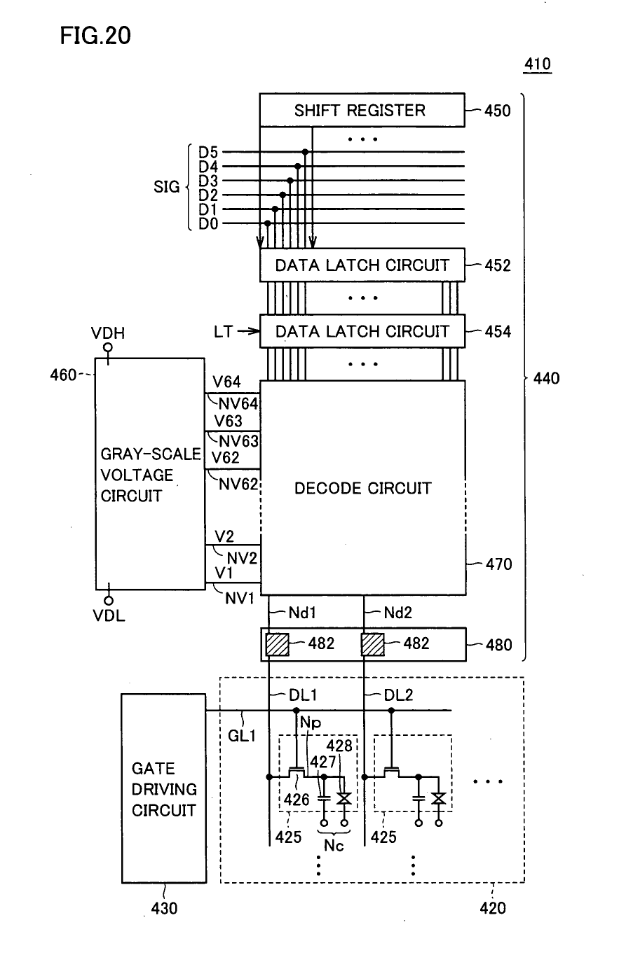

FIG. 20 is a block diagram showing an overall configuration of a liquid crystal display according to the seventh embodiment of the present invention.

With reference to FIG. 20, a liquid crystal display 410 according to the seventh embodiment of the present invention includes a liquid crystal array section 420, a gate driving circuit 430, and a data driving circuit 440.

Liquid crystal array section 420 includes plural pixels 425 arranged in a matrix. Gate lines GL are provided relatedly to respective pixel rows and data lines DL are provided relatedly to respective pixel columns. In FIG. 20, there are typically shown pixels on a first column and a second column of a first row, and gate line GL1 and data lines DL1 and DL2 related to the pixels.

Each pixel 425 has a switch element 426 provided between a corresponding data line DL and a pixel node Np, a holding capacitance 427 and a liquid crystal display element 428 connected in parallel between pixel node Np and a common electrode Nc. An orientation of a liquid crystal in liquid crystal display element 428 changes according to a voltage difference between pixel node Np and common electrode node Nc and in response to the change, a display luminance of liquid crystal display element 428 alters. Thereby, a luminance of each pixel can be controlled so as to match with a display voltage transmitted to pixel node Np through data line DL and switch element 426.

That is, by applying an intermediate voltage difference between a voltage difference corresponding to the maximum luminance and a voltage difference corresponding to the minimum luminance, across pixel node Np and common node Nc, an intermediate luminance can be obtained. That is, a display voltage is set stepwise to thereby obtain a gray-scale.

Gate driving circuit 430 activates sequentially gate lines GL in a predetermined scanning cycle. The gate of switch element 426 is connected to a corresponding gate line GL. Therefore, pixel node Np is connected to a corresponding data line DL in an activation (H level) period of the related gate line GL. Switch element 426 is generally constituted of a TFT (Thin-Film Transistor) element formed on the same insulating substrate (a glass substrate, a resin substrate or the like) as liquid display element 428. A display voltage transmitted to pixel node Np is held by holding capacitance 427.

Data driving circuit 440 outputs a display voltage set stepwise with a display signal SIG, which is a digital signal of N bits, onto data line DL. In FIG. 20, there is exemplified a case where N=6, that is, display signal SIG is composed of display signal bits D0 to D5. Gray-scale expressions at 2⁶=64 levels can be presented by each pixel using display signal SIG of 6 bits. Moreover, if one color display unit is formed from one pixel in each of R(red), G(green) and B(blue), color display in about 260, 000 colors can be enabled.

Data driving circuit 440 includes a shift register 450, data latch circuits 452 and 454, a gray-scale voltage circuit 460, a decode circuit 470, and a data line driving section 480.

Display signal SIG is generated serially in correspondence to display luminances of each pixel 425. That is, signal bits D0 to D5 at each timing indicates a display luminance at one pixel 425 in liquid crystal array section 420.

Shift register 450 commands data latch circuit 452 capture of display signal bits D0 to D5 at a timing in synchronism with a predetermined cycle in which setting of a display signal SIG is switched. Data latch circuit 452 sequentially captures display signals SIG generated serially for one pixel row and hold them.

A display signal group having been latched in data latch circuit 452 in response to activation of a latch signal LT is transmitted to data latch circuit 454 at a timing at which display signal SIG for one pixel row is captured into data latch circuit 452. Gray-scale voltage circuit 460 generates gray-scale voltages V1 to V64 at 64 levels at gray-scale voltage nodes N1 to N64.

Decode circuit 470 decodes a display signal having been latched in data latch circuit 454 to select gray-scale voltages V1 to V64 based on the decoding. Decode circuit 470 generates a selected gray-scale voltage (one of V1 to V64) at a decode output node Nd as a display voltage. In this configuration example, decode circuit 470 outputs, in parallel, display voltages for one row based on a display signal having been latched in data latch circuit 454. Note that in FIG. 20, there are typically shown decode output nodes Nd1 and Nd2 corresponding to data lines DL1 and DL2 in first and second columns, respectively.

Data line driving section 480 has data line driving circuits 482 provided relatedly to the respective data lines DL.

Data line driving circuits 482 drives data lines DL1, DL2, . . . with analog voltages corresponding to respective display voltages outputted to decode output nodes Nd1, Nd2, . . . . Each data line driving circuit 482, when in driving with the analog voltage, is necessary to supply a charging current for a parasitic capacitance of a corresponding data line DL and pixel node Np of selected pixel 425.

Therefore, a current amplifying circuit of the present invention is applied as each data line driving circuit 482. To be concrete, input nodes Ni of current amplifying circuits are connected to respective decode output nodes Nd1, Nd2, . . . and output nodes No thereof are connected to data lines DL1, DL2, . . . .

With such a configuration adopted, each data line driving circuit 482 applies a display voltage selected by decode circuit 470 to corresponding data line DL with correctness and stability while preventing oscillation to thereby enable the data line DL to be driven. While data line driving circuits 482 are required to be provided so as to be equal in number to the number of data lines DL, power consumption is suppressed in each thereof, therefore suppressing power consumption in all of the liquid crystal display 410.

Note that in FIG. 20, there is exemplified a configuration of liquid crystal display 410 in which gate driving circuit 430 and data driving circuit 440 are integrally with liquid crystal array section 420 in a single piece, gate driving circuit 430 and data driving circuit 440 can also be provided as external circuits of liquid crystal array section 420.

Eighth Embodiment

In the eighth embodiment, description will be given of a configuration of a power supply circuit of low power consumption to which a current amplifying circuit according to the present invention described above is applied.

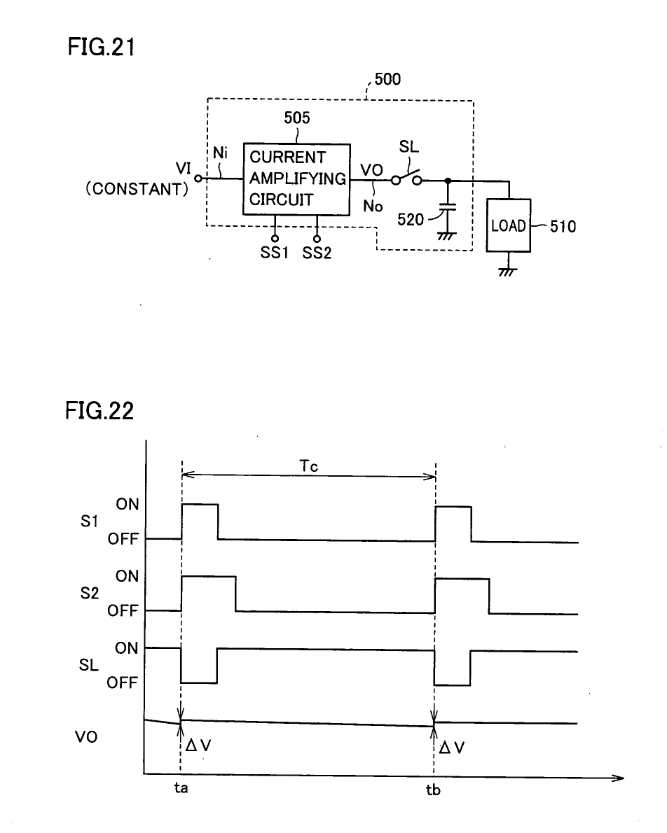

FIG. 21 is a block diagram showing a configuration of a power supply circuit according to the eighth embodiment of the present invention.

With reference to FIG. 21, a power supply circuit 500 according to the eighth embodiment includes a current amplifying circuit 505, a switch element SL, and a capacitor 520.

Current amplifying circuit 505 is a current amplifying circuit according to one of the first to seventh embodiments and the modifications thereof That is, current amplifying circuit 505 includes switch elements S1 and S2 described above and control signals SS1 and SS2 are signals controlling turning-on and -off of switch elements S1 and S2.

Current amplifying circuit 505 responds to turning-on of switch element SL provided as a “load switch” between current amplifying circuit 505 and a load 510 to supply output voltage VO to load 510. Capacitor 520 is a stabilization capacitance for obtaining output voltage VO as a constant value.

FIG. 22 is an operating waveform diagram showing operations in the power supply circuit according to the eighth embodiment of the present invention.

With reference to FIG. 22, switch elements S1 and S2 are turned on or off at timings similar to those shown in FIG. 3.

That is, after switch elements S1 and S2 are turned on at a time point ta, switch elements S1 and S2 are stepwise turned off to hold a supply current of an output transistor at a constant value. A definition is given such that a time from time point ta till time point tb when switch elements S1 and S2 are again turned on is one cycle Tc.

Switch element SL is controlled in a phase almost in the reverse of switch element S1 and turned on after output voltage VO of a current amplifying circuit reaches a steady state and a feedback loop is cut off.

Since a feedback loop is, as described above, cut off in an off period of switch elements S1 and S2, a constant current is supplied to output node No without being affected by an external noise imposed on output node No. Output voltage VO changes gradually from a predetermined reference value (that is input voltage VI) depending on a relationship between the supply current and a consumed current in a load 510. By again forming a feedback loop at time point tb, output voltage VO is again restored to input voltage VI.

That is, one cycle Tc is determined so as to include just a voltage variation ΔV of output voltage VO in the one cycle to then adjust a refresh cycle Tc so to be suitable, thereby enabling a current amplifying circuit of the present invention to be used as a power supply circuit of a low power consumption type.

Modification of Eighth Embodiment

A power supply circuit thus constructed according to the eighth embodiment can be used, for example, as a gray-scale voltage circuit in the liquid circuit display shown in FIG. 20.

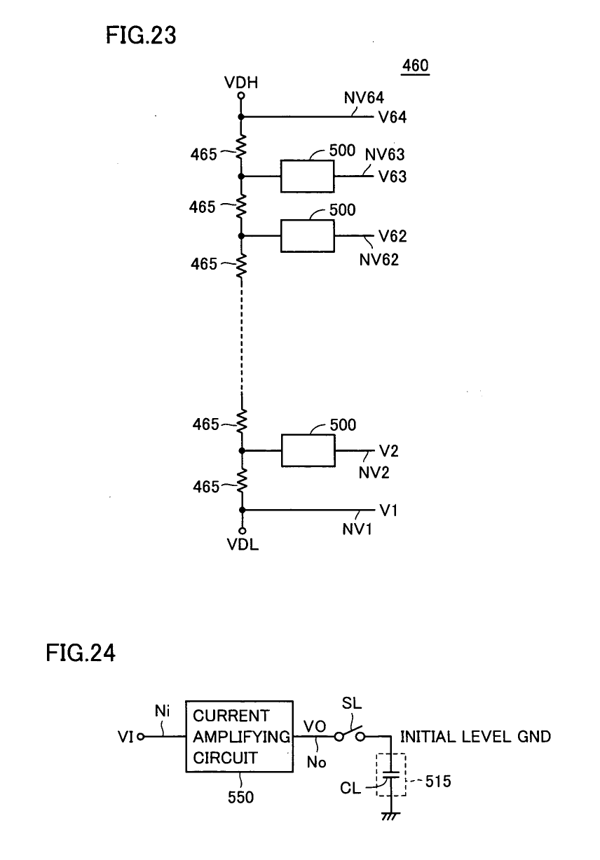

FIG. 23 is a circuit diagram showing a configuration of a gray-scale voltage circuit 460 according to the modification of the eighth embodiment of the present invention.

With reference to FIG. 23, gray-scale voltage circuit 460 includes 63 voltage dividing resistors 465 connected in series between a high voltage VDH and a low voltage VDL, and power supply circuits 500 provided relatedly to respective gray-scale voltages V2 to V63.

Gray-scale voltages at 64 levels between high voltage VDH and low voltage VDL are generated with 63 divided voltages connected in series with each other. Since gray-scale voltages V1 to V64 are extracted directly from voltage sources of high voltage VDH and low voltage VDL, no necessity arises for placement of power supply circuit 500.

In each power supply circuit 500, an input node of current amplifying circuit 505 is connected to a connection node of voltage dividing resistor 465 generating a related gray-scale voltage. An output node of current amplifying circuit 505 is connected to a corresponding gray-scale voltage node NV2 to NV63. Thereby, a related gray-scale voltage is generated at output node No of current amplifying circuit 505 to thereby enable a necessary current supply to be performed.

Intermediate gray-scale voltages V2 to V63 are generated not directly from divided voltages but with power supply currents 500, thereby enabling an output impedance of gray-scale voltage circuit 460 to be decreased. With decrease in the output impedance, gray-scale voltages V2 to V63 can be generated even if resistance values of voltage dividing resistors 465 are raised to thereby decrease current values flowing in voltage dividing resistors 465; therefore, enabling power consumption of gray-scale voltage circuit 460 to be reduced. Note that any of the other current amplifying circuits described above can be used directly as power supply circuits 500.

Ninth Embodiment

In the embodiments described above, description is given of a low power consumption operation in a current amplifying circuit including switch elements S1 and S2. In a current amplifying circuit according to the present invention, however, the effect can be exerted even only with switch element S1 for cut-off of a feedback loop while placement of switch element S2 is omitted.

For example, such a current amplifying circuit can be used as a power supply circuit connected to a capacitive load as shown in FIG. 24.

FIG. 24 is a bock diagram showing a power supply system using the current amplifying circuit 550 according to the ninth embodiment of the invention.

With reference to FIG. 24, a current amplifying circuit 550 according to the ninth embodiment of the present invention, though details are omitted in the figure, is of a configuration in which switch element S2 is omitted in one of current amplifying circuits 101 to 107, 110, 111 and others which are described above, and an operating current is supplied to current mirror amplifier 30 or 31 at all times.

A switch element SL is provided between an output node No of current amplifying circuit 550 and a capacitive load 515.

In a configuration according to FIG. 24, after output voltage VO is generated at output node No by the action of current amplifying circuit 550, output voltage VO is supplied to capacitive load 515 through switch element SL or the like.

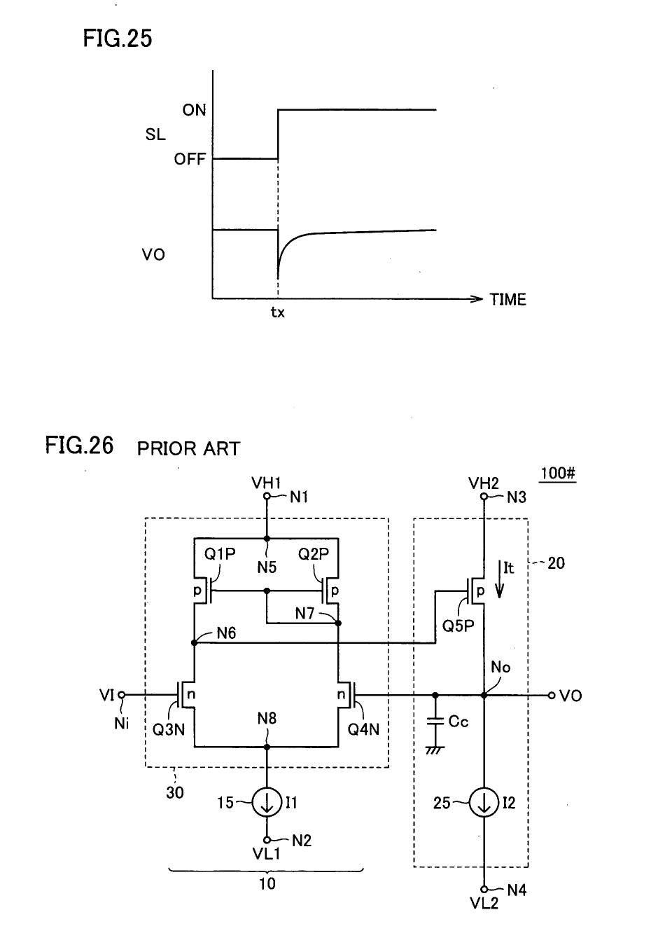

Output voltage VO, as shown in FIG. 25, rapidly decreases in an instant because of charging a load capacitance CL at a timing (a time point tx) at which switch element SL is turned on.

In this state, if a feedback loop is not cut off by switch element S1, it works as a cause for oscillation of an output of a current mirror amplifier flowing through a current amplifying circuit by the action of rapid decrease of an output voltage due to a load current. In current amplifying circuit 550, however, since a feedback loop is turned off by switch element S1 prior to turning-on of switch element SL, such oscillation does not occur.

If switch element S1 is, after output voltage VO is restored, again turned on, oscillation due to an output voltage variation immediately after load connection is prevented to thereby enable a power supply system in which a stable output voltage VO is supplied to a capacitive load to be constructed.

Although the present invention has been described and illustrated in detail, it is clearly understood that the same is by way of illustration and example only and is not to be taken by way of limitation, the spirit and scope of the present invention being limited only by the terms of the appended claims.

1. A current amplifying circuit comprising:
a differential amplification circuit for generating a voltage difference according to a voltage difference between an input node and an output node, across a first node and a second node;
an output circuit for generating a voltage and a current corresponding to a voltage at a control node, on said output node; and
a feedback loop switch provided between a predetermined one of said first and second nodes and said control node, wherein
said differential amplification circuit and said output circuit operate so that, when a feedback loop is formed by turning-on of said feedback loop switch, a voltage at said output node coincides with a voltage at said input node, and
said feedback loop switch is turned off after a voltage at said output node becomes substantially equal to a voltage at said input node by formation of said feedback loop.

2. The current amplifying circuit according to claim 1, wherein
said differential amplification circuit includes an operating current switch connected in series with an operating current source of said differential amplification circuit between a high voltage source and a low voltage source for supplying or cutting-off an operating current of said differential amplification circuit, wherein
said operating current switch is turned off to cut off said operating current after a voltage at said output node is close to a voltage at said input node.

3. The current amplifying circuit according to claim 2, wherein
said operating current switch is turned off at a time point when a predetermined time elapses after said feedback loop switch is turned off.

4. The current amplifying circuit according to claim 2, wherein
said operating current switch is constituted of a field effect transistor a gate voltage of which can be controlled.

5. The current amplifying circuit according to claim 1, wherein
said output circuit includes an output transistor, which is a field effect transistor, and a current limiting circuit connected in series between a high voltage source and a low voltage source with said output node interposed between the output transistor and the current limiting circuit,
the gate of said output transistor is connected to said control node, and
said current limiting circuit is a constant current source.

6. The current amplifying circuit according to claim 1, wherein
said output circuit includes an output transistor, which is a field effect transistor, and a current limiting circuit connected in series between a high voltage source and a low voltage source with said output node interposed between the output transistor and the current limiting circuit,
the gate of said output transistor is connected to said control node, and
said current limiting circuit is a resistance element.

7. The current amplifying circuit according to claim 1, wherein
said output circuit causes a current corresponding to a voltage at said control node to flow into said output node.

8. The current amplifying circuit according to claim 1, wherein
said output circuit causes a current corresponding to a voltage at said control node to flow out from said output node.

9. The current amplifying circuit according to claim 1, further comprising:
a feedthrough compensating circuit for compensating a voltage variation occurring at said control node when said feedback loop switch is turned off to restore a voltage at said control node to a voltage thereat directly before turning-off of said feedback loop switch.

10. The current amplifying circuit according to claim 9, wherein said feedthrough compensating circuit includes:
a capacitor connected between said control node and a third node;
a first compensation switch connected between said input node and said third node; and
a second compensation switch connected between said third node and said output node,
said second compensation switch is turned on or off at the same timing as said feedback loop switch, and
said first compensation switch is turned on after said feedback loop switch is turned off.

11. The current amplifying circuit according to claim 1, further comprising:
an offset compensating circuit for compensating an offset voltage in said differential amplification circuit to correct a voltage at said input node so that said current amplifying circuit generates an output voltage equal to an input voltage at said output node.

12. The current amplifying circuit according to claim 1, further comprising:
a load switch provided between said output node and a load, wherein
a voltage at said input node is set at a constant voltage corresponding to a supply voltage to said load, and
said load switch and said feedback loop switch are turned on or off complementarily to each other.

13. A current amplifying circuit comprising:
first and second current amplifying units, wherein
each of said first and second current amplifying units includes:
a differential amplification circuit for generating a voltage difference according to a voltage difference between an input node and an output node, across a first node and a second node;
an output circuit for generating a voltage and a current corresponding to a voltage at a control node, on said output node; and
a feedback loop switch provided between a predetermined one of said first and second nodes and said control node,
said differential amplification circuit and said output circuit operate such that, when a feedback loop is formed by turning-on of said feedback loop switch, a voltage at said output node coincides with a voltage at said input node,
said feedback loop switch is turned off after a voltage at said output node becomes substantially equal to a voltage at said input node by formation of said feedback loop,
said output circuit in said first current amplifying unit causes a current corresponding to a voltage at the control node to flow into said output node and said output circuit in said second current amplifying unit causes a current corresponding to a voltage at said related control node to flow out to said output node, and
said input nodes of said first and second current amplifying units are connected electrically to each other and said output nodes of said first and second current amplifying units are connected electrically to each other.

14. The current amplifying circuit according to claim 13, further comprising:
a switch element disposed between said output node in said first current amplifying unit and said output node in said second current amplifying unit, wherein
said switch element is turned off in an ON period of said feedback loop switch and is turned on after said feedback loop switch is turned off.

15. The current amplifying circuit according to claim 13, wherein
each of said first and second current amplifying units further includes an operating current switch connected in series with said differential amplification circuit between a high voltage source and a low voltage source for supplying or cutting off an operating current of said differential amplification circuit, and
said operating current switch is turned off and cuts off said operating current after a voltage at said output node is close to a voltage at said input node.

16. The current amplifying circuit according to claim 13, further comprising:
offset compensating circuits provided corresponding to said first and second current amplifying units, respectively, wherein
said offset compensating circuit, in each of said first and second current amplifying unit, compensates an offset voltage in said differential amplification circuit to correct a voltage at said input node so that an output voltage equal to an input voltage is generated at said output node.

17. A liquid crystal display comprising:
a plurality of pixels arranged in a matrix and emitting luminances corresponding to respective display voltages written thereinto;
a plurality of gate lines provided to the respective pixel rows and selected cyclically;
a plurality of data lines provided to the respective pixel columns; and
a data driving circuit for generating said display voltages sequentially in response to display signals indicating the display luminances of the respective pixels to output the display voltages onto said data lines, wherein
said data driving circuit includes:
a decode circuit for generating a gray-scale voltage corresponding to a decode result of said display signal as said display voltage; and
current amplifying circuits provided to the respective data lines,
each of said current amplifying circuits includes:
a differential amplification circuit for generating a voltage difference according to a voltage difference between an input node and an output node, across a first node and a second node;
an output circuit for generating a voltage and a current corresponding to a voltage at a control node, on said output node; and
a feedback loop switch provided between a predetermined one of said first and second nodes and said control node,
said differential amplification circuit and said output circuit operate such that, when a feedback loop is formed by turning-on of said feedback loop switch, a voltage at said output node coincides with a voltage at said input node,
said feedback loop switch is turned off after a voltage at said output node becomes substantially equal to a voltage at said input node by formation of said feedback loop,
said input node of each said current amplifying circuit receives said display voltage from said decode circuit and said output node of each said current amplifying circuit is connected to a corresponding one of said data lines, and
said pixels are, when a corresponding one of said gate lines is selected, connected electrically to a corresponding one of said data lines and said display voltage is written thereinto.

18. A liquid crystal display comprising:
a plurality of pixels arranged in a matrix and emitting luminances corresponding to respective display voltages written thereinto;
a plurality of gate lines provided to said respective pixel rows and selected cyclically;
a plurality of data lines provided to said respective pixel columns; and
a data driving circuit for generating said display voltages sequentially in response to display signals indicating the display luminances of the respective pixels to output the display voltages onto said data lines, wherein
said data driving circuit includes:
a decode circuit for generating a gray-scale voltage corresponding to a decode result of said display signal as said display voltage; and
current amplifying circuits provided to the respective plural data lines,
each of said current amplifying circuits includes first and second current amplifying units,
each of said first and second current amplifying units includes:
a differential amplification circuit for generating a voltage difference according to a voltage difference between an input node and an output node, across a first node and a second node;
an output circuit for generating a voltage and a current corresponding to a voltage at a control node, on said output node; and
a feedback loop switch provided between a predetermined one of said first and second nodes and said control node,
said differential amplification circuit and said output circuit operate such that, when a feedback loop is formed by turning-on of said feedback loop switch, a voltage at said output node coincides with a voltage at said input node,
said feedback loop switch is turned off after a voltage at said output node becomes substantially equal to a voltage at said input node by formation of said feedback loop,
said output circuit in said first current amplifying unit causes a current corresponding to a voltage at the control node to flow into said output node and said output circuit in said second current amplifying unit causes a current corresponding to a voltage at the control node to flow out to said output node,
said input nodes of said first and second current amplifying units are connected electrically to each other and receive said display voltage from said decode circuit,
said output nodes of said first and second current amplifying units are connected electrically to each other and further connected to a corresponding one of said data lines, and
said pixels are, when a corresponding one of said gate lines is selected, connected electrically to a corresponding one of said data lines and said display voltage is written thereinto.

19. A liquid crystal display comprising:
a plurality of pixels arranged in a matrix and emitting luminances corresponding to respective display voltages written thereinto;
a plurality of gate lines provided to the respective pixel rows and selected cyclically;
a plurality of data lines provided to the respective pixel columns; and
a data driving circuit for generating said display voltages sequentially in response to display signals indicating the display luminances of the respective pixels to output the display voltages onto said data lines, wherein
said data driving circuit includes:
a gray-scale voltage circuit for generating gray-scale voltages corresponding to plural display luminances for gray-scales to gray-scale voltage nodes, respectively;
a decode circuit for selectively outputting one of said gray-scale voltages generated at said gray-scale voltage nodes according to a decoded result of said display signal as said display voltage; and
data line driving circuits provided to the respective data lines to drive a corresponding one of said data lines with said display voltage selected by said decode circuit,
said pixels are, when a corresponding one of said gate lines is selected, connected electrically to a corresponding one of said data lines and said display voltage is written thereinto,
said gray-scale voltage circuit includes:
a plurality of voltage dividing resistors according to gray-levels in number and connected in series between a high voltage source and a low voltage source; and
current amplifying circuits provided corresponding to respective connection nodes between said voltage dividing resistors,
each of said current amplifying circuits includes:
a differential amplification circuit for generating a voltage difference according to a voltage difference between an input node and an output node, across a first node and a second node;
an output circuit for generating a voltage and a current corresponding to a voltage at a control node, on said output node; and
a feedback loop switch provided between a predetermined one of said first and second nodes and said control node,
said differential amplification circuit and said output circuit operate such that, when a feedback loop is formed by turning-on of said feedback loop switch, a voltage at said output node coincides with a voltage at said input node,
said feedback loop switch is turned off after a voltage at said output node becomes substantially equal to a voltage at said input node by formation of said feedback loop, and
said input nodes of said current amplifying circuits are connected to said connection nodes between said voltage dividing resistors and said output nodes of said current amplifying circuits are connected to the respective gray-scale voltage nodes.

20. A liquid crystal display comprising:
a plurality of pixels arranged in a matrix and emitting luminances corresponding to respective display voltages written thereinto;
a plurality of gate lines provided to the respective pixel rows and selected cyclically;
a plurality of data lines provided to the respective pixel columns; and
a data driving circuit for generating said display voltages sequentially in response to display signals indicating the display luminances of the respective pixels to output the display voltages to said plural data lines, wherein
said data driving circuit includes:
a gray-scale voltage circuit for generating gray-scale voltages corresponding to plural display luminances for gray-scale to gray-scale voltage nodes, respectively;
a decode circuit for selectively outputting one of said gray-scale voltages generated at said gray-scale voltage nodes according to a decoded result of said display signal as said display voltage; and
data line driving circuits provided to the respective data lines to drive a corresponding one of said data lines with said display voltage selected by said decode circuit,
said pixels are, when a corresponding one of said plural gate lines is selected, connected electrically to a corresponding one of said data lines and said display voltage is written thereinto,
said gray-scale voltage circuit includes:
a plurality of voltage dividing resistors according to gray levels in number and connected in series between a high voltage source and a low voltage source; and
current amplifying circuits provided corresponding to respective connection nodes between said voltage dividing resistors,
each of said current amplifying circuits includes a first and second current amplifying units,
each of said first and second current amplifying circuits includes:
a differential amplification circuit for generating a voltage difference according to a voltage difference between an input node and an output node, across a first node and a second node;
an output circuit for generating a voltage and a current corresponding to a voltage at a control node, on said output node; and
a feedback loop switch provided between a predetermined one of said first and second nodes and said control node,
said differential amplification circuit and said output circuit operate such that, when a feedback loop is formed by turning-on of said feedback loop switch, a voltage at said output node coincides with a voltage at said input node,
said feedback loop switch is turned off after a voltage at said output node becomes substantially equal to a voltage at said input node by formation of said feedback loop,
said output circuit in said first current amplifying unit causes a current corresponding to a voltage at the control node to flow into said output node and said output circuit in said second current amplifying unit causes a current corresponding to a voltage at the control node to flow out to said output node,
said input nodes of said first and second current amplifying units are connected electrically to each other and further connected to said connection nodes between said voltage dividing resistors, and
said output nodes of said first and second current amplifying units are connected electrically to each other and further connected electrically to a corresponding one of said gray-scale voltage nodes.
